(19) United States
(12) Patent Application Publication
(10) Pub. No.: US 2009/0195585 A1
(43) Pub. Date: Aug. 6, 2009

(54) Image forming method, computer-readable recording medium, image processing device, image forming apparatus, and image forming system

(75) Inventors: Taku Satoh, Kanagawa (JP); Naoki Nakano, Kanagawa (JP); Takashi Kimura, Kanagawa (JP); Masakazu Yoshida, Kanagawa (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/320,450

(22) Filed: Jan. 27, 2009

(30) Foreign Application Priority Data
Feb. 5, 2008 (JP) 2008-025294

(51) Int. Cl. B41J 2/205; H04N 1/405

(52) U.S. Cl. 347/15; 358/3.06

(57) ABSTRACT

Disclosed is an image forming method including forming an image including plural dots by using liquid drops of recording liquid, the image including a background portion and a character portion, detecting brightness characteristics of the character portion and background portion, and switching dot addition on or off, wherein a dot with a color identical to a color of the character portion is added to a contour portion of the character portion when the dot addition is switched on.

### BACKGROUND OF THE INVENTION

1. Field of the Invention

The present invention relates to an image forming method, a computer-readable recording medium, an image processing device, an image forming apparatus, and an image forming system.

2. Description of the Related Art

Conventionally, when a white blank character is recorded by using a recording liquid, there is a problem that the white blank character is thinned or a part thereof becomes vague, because recording liquid for a black portion spreads onto a white blank character portion due to the spreading of the recording liquid.

Against such a problem, Japanese Patent Application Publication No. 2007-125826 suggests a technique for thickening a white blank character, including setting the top of font data to be a picture element of interest, obtaining bitmap data of font data corresponding to a window centered on the picture element of interest, comparing the obtained data with reference pattern data for addition of preset white blank by means of pattern matching, and if they match, replacing the picture element of interest with data indicating a large liquid drop whereby a dot of a background portion (blank portion) adjacent to an image dot of the white blank character is set to be a blank dot.

Although the visibility of a character may be ensured by conducting a process for thickening a character portion in the technique, it would not be possible to attain sufficient improvement of the visibility of a non-white blank character because the thickening process is conducted by addition of a blank dot.

### SUMMARY OF THE INVENTION

According to one aspect of the present invention, there is provided an image forming method including forming an image including plural dots by using liquid drops of recording liquid, the image including a background portion and a character portion, detecting brightness characteristics of the character portion and background portion, and switching dot addition on or off, wherein a dot with a color identical to a color of the character portion is added to a contour portion of the character portion when the dot addition is switched on.

According to another aspect of the present invention, there is provided a computer-readable recording medium including a program recorded therein, wherein the program is configured to cause a computer to execute the image forming method as described above.

According to another aspect of the present invention, there is provided an image processing device, including a central processing unit configured to control the image processing device in accordance with a program, and a memory device including the program installed therein, wherein the program is configured to cause the image processing device to execute the image forming method as described above.

According to another aspect of the present invention, there is provided an image forming apparatus, including a recording head configured to eject a liquid drop of recording liquid to form an image, and an image processing part, the image processing part including a central processing unit configured to control the image processing part in accordance with a program and a memory device including the program installed therein, wherein the program is configured to cause the image processing part to execute the image forming method as described above.

According to another aspect of the present invention, there is provided an image forming system, including the image processing device as described above, and an image forming apparatus including a recording head configured to eject a liquid drop of recording liquid to form an image.

### BRIEF DESCRIPTION OF THE DRAWINGS

FIG. 1 is a side view illustrating the entire structure of a mechanical part of an image forming apparatus.

FIG. 2 is a plan view illustrating the mechanical part of the image forming apparatus.

FIG. 3 is cross-sectional diagram illustrating a recording head in the longitudinal directions of a liquid chamber.

FIG. 4 is a cross-sectional diagram illustrating the recording head in the lateral directions of the liquid chamber (the directions of nozzle alignment).

FIG. 5 is a block diagram illustrating a control part for driving the image forming apparatus.

FIG. 6 is a diagram illustrating a printing control part and a head driver.

FIG. 7 is a diagram illustrating an example of a control driving wave pattern for conducting ink ejection.

FIGS. 8A, 8B, 8C, and 8D are diagrams illustrating examples of a control driving wave pattern depending on an ink drop size.

FIG. 9 is a diagram illustrating one example of a control driving wave pattern depending on the viscosity of an ink drop.

FIG. 10 is a diagram illustrating one example of the configuration of an image forming system.

FIG. 11 is a diagram illustrating the structure of an image processing device.

FIG. 12 is a diagram illustrating an output example in the case where a character thickening process is not conducted.

FIG. 13 is a partially enlarged view thereof at the dot size in the case where a character thickening process is not conducted.

FIG. 14 is a diagram illustrating an output example in the case where a character thickening process is conducted.

FIG. 15 is a partially enlarged view thereof at the dot size in the case where a character thickening process is conducted.

FIG. 16 is a diagram illustrating a character thickening process in the case of a high resolution.

FIG. 17 is a diagram illustrating one example of a window used for pattern matching.

FIG. 18 is a diagram illustrating one example of a window used for pattern matching.

FIG. 19 is a diagram illustrating one example of an operation flow of pattern matching (a character thickening process).

FIGS. 20A, 20B, and 20C are diagrams illustrating a specific method of pattern matching.

FIGS. 21A and 21B are diagrams illustrating a specific method of pattern matching.

FIGS. 22A, 22B, 22C, and 21D are diagrams illustrating a specific method of pattern matching.

FIGS. 23A and 23B are diagrams illustrating a specific method of pattern matching.

FIG. 24 is a diagram illustrating an operation flow of switching on/off of a character thickening process depending on a character size, a character type and an image resolution.

FIGS. 25A and 25B are diagrams illustrating the case where a character thickening process is conducted without conducting pattern matching.

FIG. 26 is a diagram illustrating an operation flow in the case where a character thickening process is conducted without conducting pattern matching.

FIGS. 27A and 27B are a perspective view and cross-sectional diagram illustrating the structure of the essential part of one example of a recording head, respectively.

FIG. 28 is a cross-sectional diagram illustrating the essential part of another example of a recording head.

FIG. 29 is a schematic diagram illustrating one example of a computer-readable recording medium according to a specific example of the present invention.

### DETAILED DESCRIPTION OF THE PREFERRED EMBODIMENTS

Next, some illustrative embodiments of the present invention will be described below.

An illustrative embodiment of the present invention may relate to at least one of an image forming method and a program, image processing device, image forming apparatus, and image forming system, configured to conduct the same.

In particular, an illustrative embodiment of the present invention may relate to at least one of an image forming method configured to attain improvement of the visibility of a so-called character with background which is composed of a background portion and a character portion and facilitation of dot addition processing, and a program, image processing device, image forming apparatus, and image forming system, configured to conduct the same,

Furthermore, it may be an object of an illustrative embodiment of the present invention to provide at least one of an image forming method with a high universality which is allowed to improve the visibility of a character portion with respect to an image composed of a background portion and a character portion, and a program, image processing device, image forming apparatus, and image forming system, configured to conduct the same.

According to a first illustrative embodiment of the present invention, there may be provided an image forming method using an image forming apparatus including a function of ejecting a liquid drop of recording liquid to form an image composed of plural dots, wherein the image is composed of a background portion and a character portion, detecting brightness characteristics of the character portion and background portion, and conducting switching on/off of dot addition, wherein a process of thickening a character is conducted in which dot addition with a same color as that of the character portion is applied to a contour portion of a character when the dot addition is ON.

According to a second illustrative embodiment of the present invention, there may be provided an image forming method according to the first illustrative embodiment of the present invention, wherein the brightness characteristics of the character portion and background portion are detected and a control of a degree of the dot addition is conducted.

According to a third illustrative embodiment of the present invention, there may be provided an image forming method according to the first or second illustrative embodiment of the present invention, wherein the brightness characteristics are detected based on a quantity of recording liquid used for the character portion and background portion.

According to a fourth illustrative embodiment of the present invention, there may be provided an image forming method according to any one of the first to third illustrative embodiments of the present invention, wherein whether the dot addition on a dot is conducted or not is determined by using pattern matching between an m×n window including a picture element of interest and a predetermined pattern.

According to a fifth illustrative embodiment of the present invention, there may be provided a program configured to cause an image processing part to execute an image processing operation of creating an output datum configured to form an image by ejecting a liquid drop of recording liquid, wherein the image processing part is caused to execute an image forming method according to any one of the first to fourth illustrative embodiments of the present invention.

According to a sixth illustrative embodiment of the present invention, there may be provided an image processing device configured to conduct an image processing operation of creating an image datum to be output for an image forming apparatus including a function of ejecting a liquid drop of recording liquid to form an image composed of plural dots, wherein it includes a device configured to execute an image forming method according to any one of the first to fourth illustrative embodiments of the present invention.

According to a seventh illustrative embodiment of the present invention, there may be provided an image forming apparatus configured to form an image on a paper sheet in which a recording head configured to eject a liquid drop of recording liquid based on an image datum is installed, wherein it includes a device configured to execute an image forming method according to any one of the first to fourth illustrative embodiments of the present invention.

According to an eighth illustrative embodiment of the present invention, there may be provided an image forming system wherein it is composed of an image processing device according to the sixth illustrative embodiment of the present invention and an image forming apparatus configured to form an image in which a recording head configured to eject a liquid drop of recording liquid is installed.

According to an illustrative embodiment of the present invention, it may be possible to obtain an excellent visibility of a so-called character with background which is composed of a background portion and a character portion.

Next, some specific examples of the present invention will be described with reference to the accompanying drawings below.

An image forming method according to a specific example of the present invention is an image forming method using an image forming apparatus including a function of ejecting a liquid drop of recording liquid to form an image composed of plural dots.

While the image is composed of a background portion and a character portion, the brightness characteristics of the character portion and background portion are detected and switching on/off of the dot addition is conducted, wherein it the dot addition is ON, a process for thickening a character is conducted in which dot addition with the same color as that of the character portion is applied on the contour portion of the character.

The image forming method according to a specific example of the present invention is illustrated in conjunction with an image forming apparatus for executing the same, with reference to the drawings.

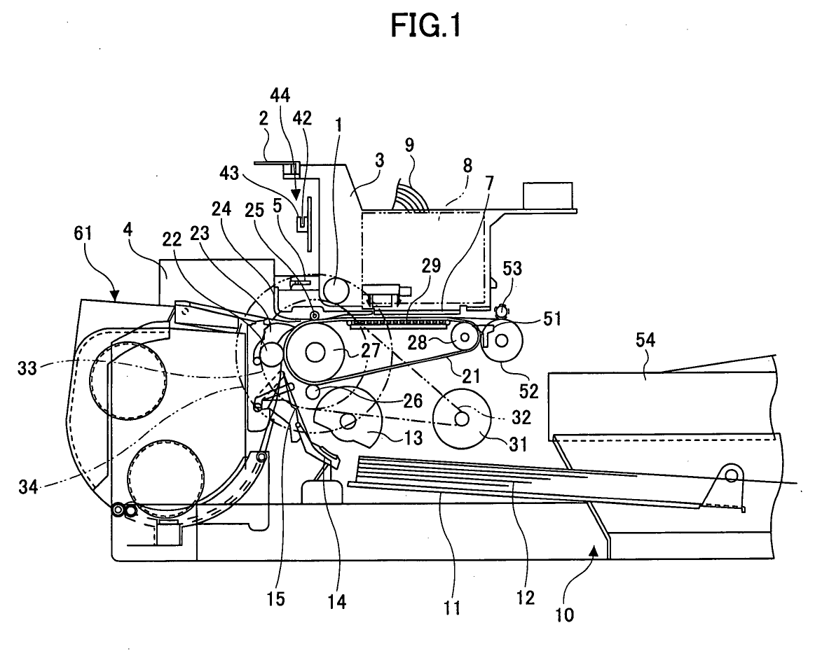

FIG. 1 is a side view illustrating the entire structure of a mechanical part of an image forming apparatus.

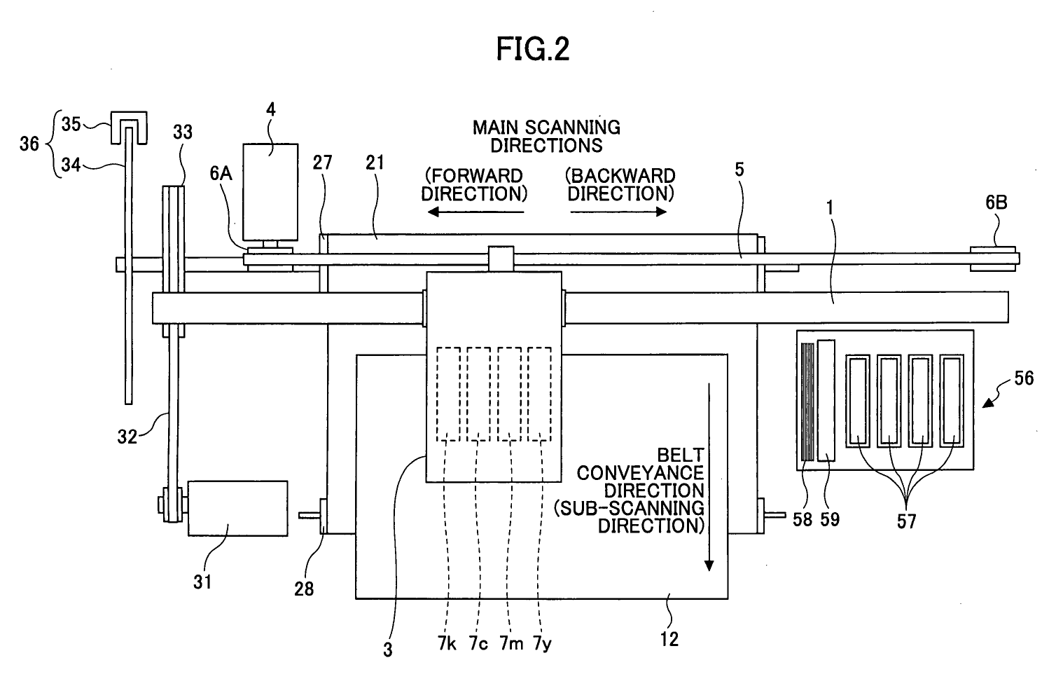

FIG. 2 is a plan view illustrating the mechanical part of the image forming apparatus.

The image forming apparatus has a configuration such that a carriage 3 is held slidably in the main scanning directions by a guide rod 1 and a guide rail 2 which are guide members.

The carriage is provided to move for scanning in the directions of arrows in FIG. 2 (the main scanning directions) with a timing belt 5 extending on a driving pulley 6A and a driven pulley 6B by means of a main scanning motor 4.

On the carriage 3, for example, four recording heads 7y, 7c, 7m, 7k (referred to as a “recording head 7” when the colors are not distinguished) for ejecting ink drops of yellow (Y), cyan (C), magenta (M) and black (B), respectively, are arranged such that the plural ink ejection ports intersect the main scanning directions.

For the recording head, it is possible to appropriately use one which includes, as a pressure generating device for generating a pressure for ejecting a liquid drop, a piezoelectric actuator such as a piezoelectric element, a thermal actuator utilizing a phase change of liquid which is caused by film boiling using an electrothermal element such as a heat element, a shape memory alloy actuator using a metal phase change caused by a temperature change, an electrostatic actuator using an electrostatic force, and the like.

Furthermore, it is not limited to the independent head configuration with respect to each color and may also be one or more liquid ejecting heads including a nozzle sequence composed of plural nozzles for ejecting liquid drops of plural colors.

On the carriage 3, a sub-tank 8 for supplying ink to the recording head 7 is mounted. To the sub-tank 8, ink is fed or supplied from an ink cartridge (not illustrated in the figures) through an ink supply tube 9.

Meanwhile, a paper feeding part for feeding paper sheets 12 stacked on a paper sheet stacking part (platen) such as a paper feeding cassette 10 includes a meniscus control roller (paper feeding roller) 13 for separating and feeding paper sheets 12 from the paper sheet stacking part 11 one by one and a separation pad 14 which opposes to the paper feeding roller 13 and is made of a material with a large frictional coefficient, wherein the separation pad 14 is pressurized to the side of the paper feeding roller 13.

Then, a conveyor belt 21 for electrostatically attracting and conveying a paper sheet 12, a counter-roller 22 for conveying and sandwiching a paper sheet 12 delivered from the paper feeding part through a guide 15 between it and the conveyor belt 21, a conveyor guide 23 for changing the course of a paper sheet 12 delivered generally vertically and upward by approximately 90° and placing it on the conveyor belt 21, and a push control roller 25 pressurized by a push member 24 to the side of the conveyor belt 21 included so as to convey the paper sheet 12 to the lower side of the recording head 7.

A charging roller 26 which is a charging device for electrically charging the surface of the conveyor belt 21 is also included.

The conveyor belt 21 is an endless belt, which extends on a conveyor roller 27 and a tension roller 28 and is configured to rotate to a belt conveyance direction in FIG. 2 (sub-scanning direction) while the conveyor roller 27 is rotated with a timing belt 32 and a timing roller 33 by means of a sub-scanning motor 31.

Additionally, a guide member 29 is arranged at the back side of the conveyor belt 21 in accordance with an image forming area of the recording head 7.

Furthermore, the charging roller 26 is arranged to contact the surface layer of the conveyor belt 21 and rotates according to the one-directional rotation of the conveyor belt 21.

Moreover, as illustrated in FIG. 2, a slit disk 34 is attached to the spindle of the conveyor roller 27 and a sensor 35 for sensing the slit of the slit disk 34 is provided, wherein the slit disk 34 and the sensor 35 constitute a rotary encoder 36.

For a paper ejecting part for ejecting a paper sheet 12 after recording, there are provided a separation claw 51 for separating a paper sheet 12 from the conveyor belt 21, a paper ejecting roller 52, a paper ejection control roller 53, and a paper ejection tray 54 for stocking an ejected paper sheet 12.

Furthermore, a double-sided paper feeding unit 55 is detachably attached to the backside. The double-sided paper feeding unit 55 receives and reverses a paper sheet 12 returned by the reverse-directional rotation of the conveyor belt 21 and feeds the paper sheet between the counter roller 22 and the conveyor belt 21 again.

Moreover, as illustrated in FIG. 2, a maintenance-recovery mechanism 56 for maintaining or recovering the condition of a nozzle of the recording head 7 is arranged in a non-printing area at one side of the scanning directions of the carriage 3.

The maintenance-recovery mechanism 56 includes a cap 57 for capping a nozzle face of the recording head 7, a wiper blade 58 which is a blade member for wiping a nozzle face, a blank ejection receiver 59 for receiving a liquid drop when blank ejection for ejecting a liquid drop that does not contribute to recording is conducted so as to eliminate a thickened recording liquid, and the like.

In the image forming apparatus having the configuration described above, the paper sheet 12 is guided by a guide 15, sandwiched and conveyed between the conveyor belt 21 and the counter roller 22, and pressurized onto the conveyor belt 21 by means of a push control roller 25 while the tip is further guided by the conveyor guide 23 such that the conveyance direction is changed by approximately 90°. Then, an alternating voltage from an AC bias supplying part which voltage alternates positive and negative ones is applied on the charging roller 26 by a certain control part (not illustrated in the figures) so that the conveyor belt 21 is charged in an alternating charging voltage pattern, that is, a pattern which alternates predetermined plus and minus spans in the sub-scanning directions that are rotation directions. As a paper sheet 21 is fed and sent to the charged conveyor belt 21, the paper sheet 12 is attracted to the conveyor belt 21 by means of an electrically static force and the paper sheet 12 is conveyed in the sub-scanning directions by the rotational motion of the conveyor belt 21. Herein, while the carriage 3 is moved to the forward or backward direction and the recording head 7 is driven in response to an image signal, ink drops are ejected onto the stopping paper sheet 12 so as to record one line, and after the paper sheet 12 is conveyed by a predetermined distance, recording of a next line is conducted.

When a recoding end signal or a signal for the back end of the paper sheet 12 having reached a recording area is received, the recording operation is finished and the paper sheet 12 is ejected onto the paper ejection tray 54.

Furthermore, in the case where double-sided printing is conducted, when recording of the front surface (the firstly-printed surface) is finished, the conveyor belt 21 is reversely rotated so as to deliver a recorded paper sheet 12 into a double-sided paper feeding unit 61, and the paper sheet 12 is reversed (on the condition that the back surface is a surface to be printed) and fed into between the counter roller 22 and the conveyor belt 22 again. After delivery onto the conveyor belt 21 is made similarly to the above descriptions by conducting a timing control and recording on the back surface is conducted, paper sheet ejection is made onto the paper ejection tray 54.

Moreover, during the standby for printing (recording), the carriage 3 is moved to the side of the maintenance-recovery mechanism 56 and a nozzle face is capped with a cap 57 so as to keep it on the wetting condition.

Furthermore, a recovery operation for eliminating thickened recording liquid or air bubbles is conducted by suctioning the recording liquid from the nozzles on the condition that the recording head 7 is capped and wiping is conducted with the wiper blade 58 in order to clean and eliminate ink adhering to the nozzle faces of the recording head 7 in the recovery operation. In addition, a blank ejection operation is conducted before the start of recording or during the recording. Thereby, it is possible to maintain a stable ejection performance of the recording head 7.

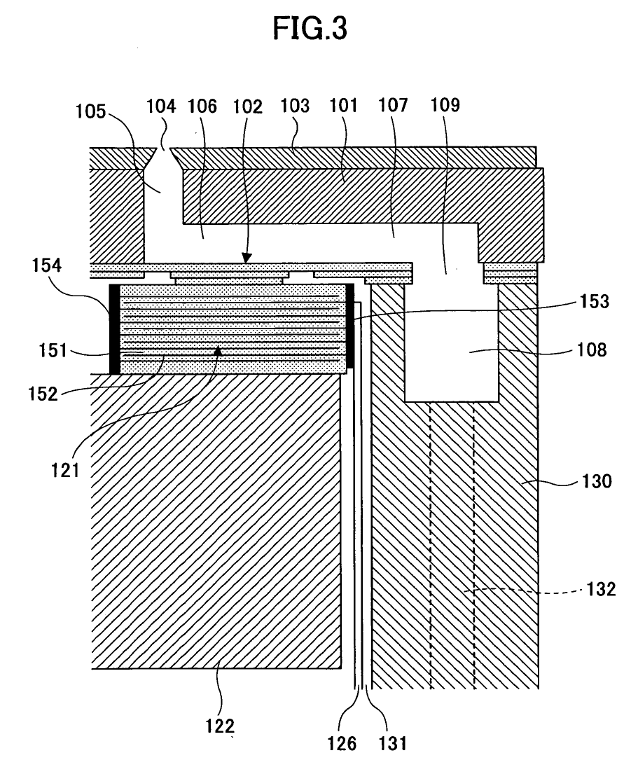

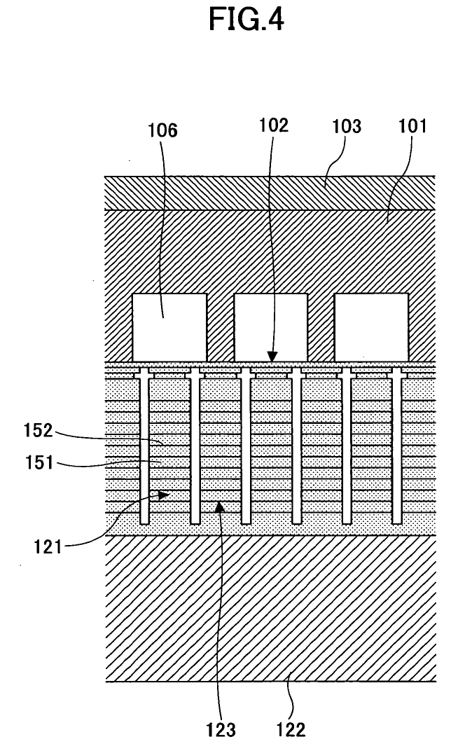

Next, one example of a liquid ejecting head constituting the recording head 7 will be described with reference to FIG. 3 and FIG. 4.

FIG. 3 is cross-sectional diagram illustrating a recording head in the longitudinal directions of a liquid chamber.

FIG. 4 is a cross-sectional diagram illustrating the recording head in the lateral directions of the liquid chamber (the directions of nozzle alignment).

The recording head (liquid ejecting head) has a configuration such that a flow channel plate 101 formed by, for example, anisotropically etching a single crystal silicon substrate, a vibrating plate 102 joined to the lower surface of the flow channel plate 101 and formed by means of, for example, nickel electroforming, and a nozzle plate 103 joined to the top surface of the flow channel plate 101 are joined and stacked so as to provide a nozzle communication channel 105 that is a flow channel communicating with a nozzle 104 for ejecting a liquid drop (ink drop), a liquid chamber 106 that is a pressure generating chamber, an ink supplying port 109 communicating with a common liquid chamber 108 for supplying ink to the liquid chamber 106 through a fluid resistance part (supplying channel) 107 and the like.

Also, stacked piezoelectric elements 121 as electromechanical elements which are pressure generating devices (actuator devices) for pressurizing ink in the liquid chamber 106 and a base substrate 122 for joining and fixing the piezoelectric elements 121 are included.

Additionally, supporting pillar parts 123 are provided between the piezoelectric elements 121. The supporting pillar parts 123 are simultaneously formed with the piezoelectric elements 121 by dividing and processing a piezoelectric member, but function as simple supporting pillars because no driving voltage is applied thereon.

Moreover, the piezoelectric elements 121 are connected to FC cables 126 in which a certain driving circuit (driving IC) is installed. In addition, the peripheral portion of the vibrating plate 102 is connected to a frame member 130, wherein the frame member 130 is provided with recesses provided for a perforation part 131 for containing an actuator unit composed of the piezoelectric elements 121, the base substrate 122 and the like and the common liquid chamber 108, and an ink supply port 132 for supplying ink from the outside to the common liquid chamber 108.

The frame member 130 is formed by means of injection molding of, for example, a thermosetting resin such as an epoxy-type resin or a poly(phenylene sulphite).

Herein, the flow channel plate 101 is provided by forming recesses and holes provided for the nozzle communication channel 105 and the liquid chamber 106 by conducting, for example, anisotropically etching of a single crystal silicon substrate with a crystallographic orientation (110), with an alkaline etching liquid such as an aqueous solution of potassium hydroxide (KOH). Additionally, it is not limited to the single crystal silicon substrate but a stainless substrate, photosensitive resins and the like are also applicable.

The vibrating plate 102 is formed from a metal plate of nickel and may be fabricated by, for example, an electroforming method (electrocasting method). The vibrating plate 102 is joined to the piezoelectric elements 121 and the supporting pillar parts 123 by means of an adhesive and further joined to the frame member 130.

The nozzle plate 103 is provided with a nozzle 104 with a diameter of 10-30 μm which corresponds to each liquid chamber 106, and is joined to the flow channel plate 101 by means of an adhesive. The nozzle plate 103 has a configuration such that a water-repellent layer is formed on the top surface of a desired layer on the surface of a nozzle forming member composed of a metal member.

The piezoelectric elements 121 are stacked piezoelectric elements (herein, PZTs) in which piezoelectric materials 151 and internal electrodes 152 are stacked alternately.

A separate electrode 153 and a common electrode 154 are connected to each of the internal electrodes 152 which are alternately led to the different end faces of the piezoelectric element 121.

Furthermore, it is possible to provide a configuration such that one line of piezoelectric elements 121 is provided on one substrate 122.

In thus configured liquid ejecting head, when the piezoelectric element 121 is contracted by, for example, decreasing a voltage applied to the piezoelectric element 121 than a reference electric potential, the vibrating plate 102 moves downward and the volume of the liquid chamber 106 increases, whereby ink flows into the liquid chamber 106. Subsequently, the voltage applied to the piezoelectric element 121 is increased so as to stretch the piezoelectric element 121 in the stacking directions, to deform the vibrating plate 102 toward the direction of the nozzle 104, and to reduce the volume of the liquid chamber 106, whereby recording liquid in the liquid chamber 106 is pressurized so as to eject (jet) a drop of recording liquid from the nozzle 104.

Then, the vibrating plate 102 returns to its initial position by setting the voltage applied to the piezoelectric element 121 back to the reference electric potential, whereby the liquid chamber 106 expands so as to generate a negative pressure, and then, the inside of the liquid chamber 106 is filled with recording liquid from the common liquid chamber 108.

Then, the vibration of a meniscus surface at the nozzle 104 damps, and after stabilization, transition to an operation for next liquid drop ejection is made.

Additionally, the method for driving the head is not limited to the above example (pull-push-ejection) but it is possible to conduct pull-ejection or push-ejection depending on the manner of providing a driving wave pattern.

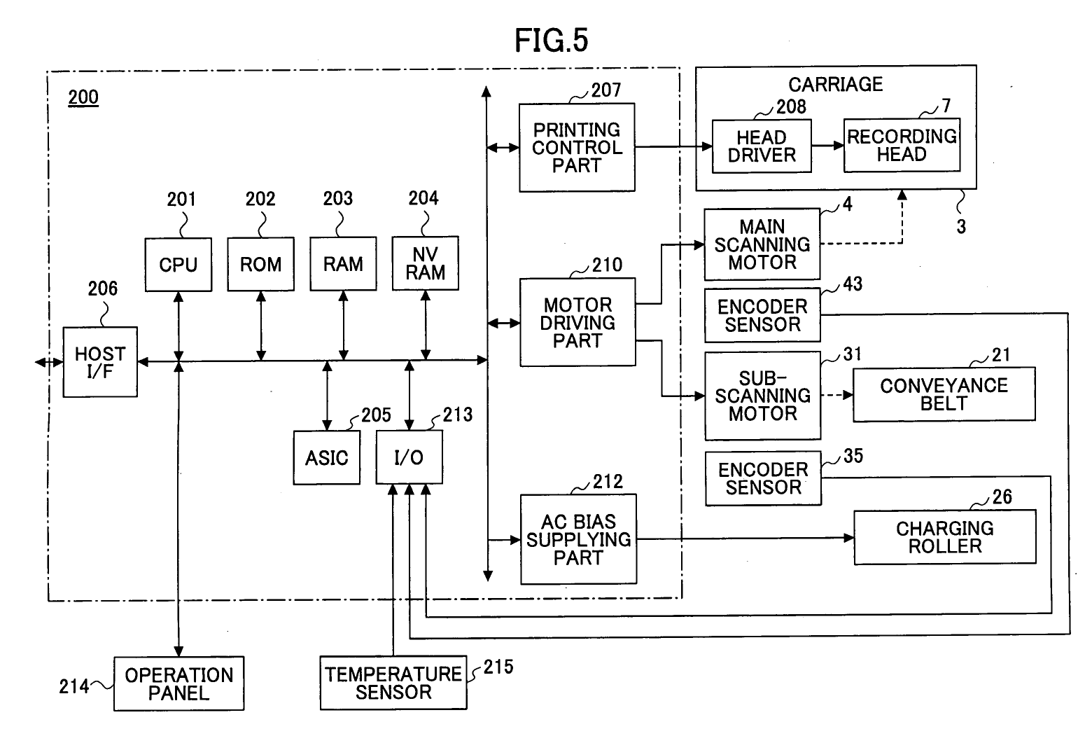

Next, the general configuration of a control part for driving the image forming apparatus described above will be described with reference to the block diagram of FIG. 5.

A control part 200 includes a CPU 211 serving to control the entire of an image forming apparatus, a program executed by the CPU 211, a ROM 202 for storing the other fixed data, a RAM 203 for temporarily storing image data and the like, a rewritable non-volatile memory 204 for holding data even when a power supply of the apparatus is switched off, and an ASIC 205 for various kinds of signal processing for image data, for an image processing for conducting sorting and the like, and for processing input and output signals for controlling the entire apparatus.

The control part 200 also includes an I/F 206 for conducting the transmission and reception of data or a signal to or from a host, a data transfer device for driving and controlling the recording head 7, a printing control part 207 including a driving wave pattern generating device for generating a driving wave pattern, a head driver (driver IC) 208 for driving the recording head 7 provided at the side of the carriage 3, a motor driving part 210 for driving the main scanning motor 4 and the sub-scanning motor 31, an AC bias supplying part 212 for supplying an AC bias to the charging roller 34, an I/O 213 for inputting each detection signal from encoder sensors 43, 35, a detection signal from each kind of sensor such as a temperature sensor for detecting an environmental temperature.

Also, the control part 200 is connected to an operation panel 214 for conducting input or display of necessary information.

Herein, the control part 200 is configured to receive image data from a host such as an information processing device such as a personal computer, an image reading device such as an image scanner, or an imaging device such as a digital camera, on the I/F 206 through a cable or network.

Then, the CPU 201 of the control part 200 reads and analyzes print data in a signal receiving buffer included in the I/F 206, conducts a necessary image processing on the ASIC 205, conducts data sort processing and the like, and transfers the image data from the head driving control part 207 to the head driver 208.

Additionally, generation of dot pattern data for image output is conducted at a printer drive at the host side, as described below.

The printing control part 207 not only transfers the above-described image data to the head driver 208 in the manner of serial data and outputs a transfer clock or latch signal necessary for transfer of the image data, determination of the transfer and the like and a drop control signal (mask signal), and the like to the head driver 208, but also includes a D/A converter for D/A converting pattern data of a driving signal stored in the ROM, a driving wave pattern generating part composed of an electric voltage amplifier, an electric current amplifier and the like, and a device for selecting a driving wave pattern provided for the head driver, whereby a driving wave pattern composed of one driving pulse (driving signal) or plural driving pulses (driving pulses) is generated and output to the head driver 208.

The head driver 208 drives the recording head 7 by selectively applying a driving signal constituting a driving wave pattern provided from the printing control part 207 to a driving element (for example, a piezoelectric element as described above) for generating energy for ejecting a liquid drop from the recording head 7 based on serially input image data corresponding to one line for the recording head 7. Then, it is possible to selectively eject dots with different sizes such as large drops (large dots), middle drops (middle dots) and small drops (small dots) by selecting a driving pulse constituting a driving wave pattern.

Furthermore, the CPU 201 calculates a driving output vale (control value) for the main scanning motor 4 based on a speed detection value and position detection value obtained by sampling a detection pulse from the encoder sensor 43 constituting a linear encoder and a speed target value and position target value obtained from preliminarily stored speed and position profiles, and drives the main scanning motor 4 via the motor deriving part 210.

Similarly, a driving output value (control value) for the sub-scanning motor 31 is calculated based on a speed detection value and position detection value obtained by sampling a detection pulse from the encoder sensor 35 constituting a rotary encoder and a speed target value and position target value obtained from preliminarily stored speed and position profiles, and the sub-scanning motor 31 is driven via the motor driving part 210 and a motor driver.

Next, one example of the printing control part 207 and head driver 208 will be described with reference to FIG. 6.

As described above, the printing control part 207 includes a driving wave pattern generation part 301 for generating and outputting a driving wave pattern (common driving wave pattern) composed of plural driving pulses (driving signals) in one printing time period and a data transfer part 302 for outputting two bits of image data corresponding to a printing image (tone signal 0 or 1), a clock signal, a latch signal (LAT), and drop control signals M0-M3.

Additionally, the drop control signal is two bits of signal for specifying, for every drop, open or close of an analog switch 317 which is the under-mentioned switching device of the head driver 208, wherein the state transition to an H level (ON) is conducted at a wave patter which should be selected according to the printing time period of the common driving wave pattern and the state transition to an L level (OFF) is conducted at the time of no selection.

The head driver 208 includes a shift register 311 for inputting a transfer clock (shift clock) and serial image data (tone data: two bits/CH) from the data transfer part 302, a latch circuit 312 for latching each registered value of the shift register 311 according to a latch signal, a decoder 313 for decoding the tone data and the control signals M0-M3 and outputting the results thereof, a level shifter 314 for level-converting a logic level voltage signal of the decoder 313 into a level at which an analog switch 513 is operable, and a analog switch 316 which is turned on or off (opened or closed) according to an output of the decoder 313 provided via the level shifter 314.

The analog switch 316 is connected to a selection electrode (separate electrode) 154 of each piezoelectric element 121 and a common driving wave pattern is input from the driving wave pattern generating part 301.

Therefore, the analog switch 316 is turned on depending on the result of decoding serially transferred image data (tone data) and control signals MN0-MN3 in the decoder 313, whereby a desired driving signal constituting a common driving wave pattern is passed (selected) and applied to the piezoelectric element 121.

Next, recording liquid (ink) for use in an image forming apparatus will be described.

Recording liquid including the following components (1) to (10) is applicable and, that is, is composed of (1) 6 wt % or more of a pigment (self-dispersion pigment), (2) wetting agent 1, (3) wetting agent 2, (4) a water-soluble organic solvent, (5) an anionic or nonionic surfactant, (6) a polyol or glycol ether with a carbon number of 8 or more, (7) an emulsion, (8) antiseptic agent, a pH adjustor, and (10) pure water.

It includes the pigment to be used as a coloring agent for character printing (recording) and the solvent to dissolve or disperse the same, as essential components, and further the wetting agents, the surfactant, the emulsion, the antiseptic agent, and the pH adjustor, as additives. The reasons why the two kinds of (different) wetting agents are mixed are to exploit the characteristic of each wetting agent and to facilitate viscosity adjustment.

The components of ink are specifically described below.

First, in regard to (1) a pigment, its kind is not particularly limited and it is possible to use an inorganic pigment or an organic pigment. For the inorganic pigment, it is possible to use carbon blacks manufactured by the publicly-known methods such as a contact method, a furnace method, and a thermal method, as well as titanium oxide and iron oxides. Also, for the organic pigment, it is possible to use azo pigments (including azo lakes, insoluble azo pigments, condensation azo pigments, chelate azo pigments, and the like), polycyclic azo pigments (for example, phthalocyanine pigments, perylene pigments, perynone pigments, anthraquinone pigments, quinacridone pigments, dioxadine pigments, thioindigo pigments, isoindolinone pigments, quinofuralone pigments, and the like), dye chelates (for example, basic dye-type chelates, acidic dye-type chelates, and the like), nitro pigments, nitroso pigments, aniline black, and the like. Among these pigments, good affinity with water is preferable. The particle diameter of a pigment is preferably from 0.05 μm to 10 μm, more preferably 1 μm or less, and most preferably 0.16 μm or less. The content of a pigment as a coloring agent in ink is preferably about 6-20% by weight and more preferably about 8-12% by weight.

For specific examples of a preferable pigment, the followings are provided.

For the black color, there are provided carbon blacks (C. I. pigment black 7) such as furnace black, lamp black, acetylene black, and channel black, metal-based ones such as copper, iron (C.I. pigment black 11), and titanium oxide, and organic pigments such as aniline black (C.I. pigment black 1).

For colors, there are provided C.I. pigment yellows 1 (fast yellow G), 2, 3, 12 (disazo yellow AAA), 13, 14, 17, 24, 34, 35, 37, 42 (yellow oxide), 53, 55, 81, 83 (disazo yellow HR), 95, 97, 98, 100, 101, 104, 108, 109, 110, 117, 120, 138, and 153, C.I. pigment oranges 5, 13, 16, 17, 36, 43, and 51, C.I. pigment reds 1, 2, 3, 5, 17, 22 (brilliant fast scarlet), 23, 31, 38, 48:2 (permanent red 2B (Ba)), 48:2 (permanent red 2B (Ca)), 48:3 (permanent red 2B (Sr)), 48:4 (permanent red 2B (Mn)), 49:1, 52:2, 53:1, 57:1 (brilliant carmine 6B), 60:1, 63:1, 63:2, 64:1, 81 (rhodamine 6G lake), 83, 88, 101 (red iron oxide), 104, 105, 106, 108 (cadmium red), 112, 114, 122 (quinacridone magenta), 123, 146, 149, 166, 168, 170, 172, 177, 178, 179, 185, 190, 193, 209, and 219, C.I. pigment violets 1 (rhodamine lake), 3, 5:1, 16, 19, 23, and 38, C.I. pigment blues 1, 2, 15 (phthalocyanine blue R), 15:1, 15:2, 15:3 (phthalocyanine blue E), 16, 17:1, 56, 60, and 63, C.I. pigment greens 1, 4, 7, 8, 10, 17, 18, and 36, and the like.

In addition, it is possible to use graft pigments in which the surface of a pigment (for example, carbon) is treated with a resin or the like to be dispersible in water, processed pigments in which the surface of a pigment (for example, carbon) is provided with a functional group such as sulfone group or a carboxyl group to be dispersible in water, and the like.

Also, it may be a pigment included in a microcapsule such that the pigment is dispersible in water.

For a dispersing agent, it is possible to use any of conventionally- or publicly-known pigment dispersion liquids.

Its specific examples are provided below.

For example, there are provided polyacrylic acids, polymethacrylic acids, acrylic acid-acrylonitrile copolymers, vinyl acetate-acrylic acid ester copolymers, acrylic acid-alkyl acrylate copolymers, styrene-acrylic acid copolymers, styrene-methacrylic acid copolymers, styrene-acrylic acid-alkyl acrylate copolymers, styrene-methacrylic acid-alkyl acrylate copolymers, styrene-α-methylstyrene-acrylic acid copolymers, styrene-α-methylstyrene-acrylic acid-alkyl acrylate copolymers, styrene-maleic acid copolymers, vinylnaphthalene-maleic acid copolymers, vinyl acetate-ethylene copolymers, vinyl acetate-fatty-acid vinyl ester-ethylene copolymers, vinyl acetate-maleic acid ester copolymers, vinyl acetate-crotonic acid copolymers, vinyl acetate-acrylic acid copolymers, and the like.

The weight-average molecular weight of the copolymer described above is preferably 3000-50000, more preferably 5000-30000, and most preferably 7000-15000.

The dispersing agent is appropriately added whose content is in a range such that a pigment is dispersed stably without losing other effects.

The ratio of a dispersing agent to a pigment is preferably in a range of 1:0.06-1:3, and more preferably in a range of 1:0.125-1:3.

The content of a pigment used as a coloring agent is preferably 6% by weight-20% by weight with respect to the total weight of an ink for recording.

Furthermore, the particle diameter is preferably 0.05 μm-0.16 μm, wherein dispersion in water is attained by a dispersing agent. For the dispersing agent, a polymer dispersing agent with a molecular weight of 5000-100000 is preferable.

Additionally, it was confirmed that image quality is improved when a pyrolidone derivative, in particular 2-pyrolidone, is used for at least one kind of the (4) water-soluble organic solvent described above.

The (2) and (3) wetting agents 1 and 2 described above and the (4) water-soluble organic solvent described above are used for purposes of preventing ink from drying, improving the dissolution stability and the like, in the case where water is used for a liquid medium of ink. Additionally, the water-soluble organic solvent may be used solely or plural kinds thereof may be mixed and used.

Specific examples of the (2) and (3) wetting agents 1 and 2 and (4) water-soluble organic solvent described above are provided below.

For example, there are provided polyhydric alcohols such as ethylene glycol, diethylene glycol, triethylene glycol, propylene glycol, dipropylene glycol, tripropylene glycol, tetraethylene glycol, hexylene glycol, polyethylene glycol, polypropylene glycol, 1,5-pentanediol, 1,6-hexanediol, glycerol, 1,2,6-hexanetriol, 1,2,4-butanetriol, 1,2,3-butanetriol, and petriol, polyhydric alcohol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether, polyhydric alcohol aryl ethers such as ethylene glycol monophenyl ether and ethylene glycol monobenzyl ether, nitrogen-containing heterocyclic compounds such as 2-pyrolidone, N-methyl-2-pyrolidone, N-hydroxyethyl-2-pyrolidone, 1,3-dimethylimidazolidinone, ε-caprolactam, and γ-butyrolactone, amides such as formamide, N-methylformamide, and N,N-dimethylformamide, amines such as monoethanolamine, diethanolamine, triethanolamine, monoethylamine, diethylamine, and triethylamine, sulfur-containing compounds such as dimethyl sulfoxide, sulfolane, and thiodiethanol, propylene carbonate, ethylene carbonate, and the like.

Among the organic solvents described above, particularly preferable are diethylene glycol, thiodiethanol, polyethylene glycol (molecular weight: 200-600), triethylene glycol, glycerol, 1,2,6-hexanetriol, 1,2,4-butanetriol, petriol, 1,5-pentanediol, 2-pyrolidone, and N-methyl-2-pyrolidone. Thereby, it is possible to obtain an excellent effect on the solubility and prevention of a defective ejection characteristic caused by water vaporization.

For other wetting agents, saccharides are applicable.

For the saccharides, there are provided monosaccharides, disaccharides, oligosaccharides (including trisaccharides and tetrasaccharides) and polysaccharides and specifically, there are provided glucose, mannose, fructose, ribose, xylose, arabinose, galactose, maltose, cellobiose, lactose, sucrose, trehalose, maltotriose, and the like.

Herein, polysaccharides mean generalized saccharides and include substances that widely exist in nature, such as α-cyclodextrin and celluloses.

Furthermore, for derivatives of the saccharides described above, there are provided reducing sugars (represented by, for example, sugar alcohols (general formula HOCH₂(CHOH)ₙCH₂OH (wherein n represents an integer of 2-5))), oxidized sugars (for example, aldonic acids, uronic acid, and the like), amino acids, thio acids, from the saccharides described above, and the like. For the saccharide derivatives, sugar alcohols are particularly preferable and for specific examples thereof, there are provided maltitol, sorbitol, and the like.

The content of the saccharide(s) is 0.1-40% by weight of an ink composition, and more preferable is in a range of 0.5-30% by weight.

The (5) surfactant described above is not particularly limited.

For the anionic surfactant, there are provided, for example, polyoxyethylene alkyl ether acetates, dodecylbenzenesulfonates, laurylates, polyoxyethylene alkyl ether sulfates, and the like.

For the nonionic surfactant, there are provided, for example, polyoxyethylene alkyl ethers, polyoxyethylene alkyl esters, polyoxyethylene sorbitan fatty acid esters, polyoxyethylene alkyl phenyl ethers, polyoxyethylene alkyl amines, polyoxyethylene alkyl amides, and the like.

The surfactant may be used solely or two or more kinds thereof may be mixed.

Meanwhile, the surface tension of ink is an important index representing its penetrability into a paper sheet, wherein the dynamic surface tension in a short time period of 1 second or less after surface formation is particularly concerned and is different from the static surface tension measured for a saturation time period.

For the measurement method, a method using a Wilhelmy suspended-plate-type surface tension balance is applicable.

The surface tension value of ink is preferably 40 mJ/m² or less, and more preferably 35 mJ/m² or less, and then it was confirmed that excellent fixation property and drying property are obtained.

The (6) polyol or glycol ether with a carbon number of 8 or more described above is described. This functions as a penetrating agent.

For the penetrating agent, a partially-water-soluble polyol and/or glycol ether is used which has a solubility of 0.1-less than 4.5% by weight in water at 25° C.

It is preferable to add a 0.1-10.0% by weight thereof with respect to the total amount of ink. Thereby, it was confirmed that the wettability of ink for a thermal element is improved and the ejection stability and frequency stability is obtained.

Specifically, the followings (A) and (B) are preferable.

(A) 2-ethyl-1,3-hexanediol solubility: 4.2% (20° C.).

(B) 2,2,4-trimethyl-1,3-pentanesiol solubility: 2.0% (25° C.).

The penetrating agent having a solubility of 0.1-less than 4.5% by weight in water at 25° C. has an advantage such that its penetrability is very high although the solubility is low. Therefore, it was confirmed that an ink with a high penetrability may be obtained by combining the penetrating agent having a solubility of 0.1-less than 4.5% by weight in water at 25° C. with another solvent or combining it with another surfactant.

The (7) emulsion described above is described.

It is preferable that a resin emulsion be added in ink.

Herein, the resin emulsion is an emulsion whose continuous phase is water and whose dispersed phase is a resin component described below.

For the resin component of the dispersed phase, there are provided acrylic resins, vinyl acetate-type resins, styrene-butadiene-type resins, vinyl chloride-type resins, acryl-styrene-type resins, butadiene-type resins, styrene-type resins, and the like. It is preferable that the resin is a polymer having both a hydrophilic portion and a hydrophobic portion.

Furthermore, the particle diameter of the resin component is not particularly limited and is preferably about 150 nm or less and more preferably about 5-100 nm.

A resin emulsion is obtained by mixing a resin particle together with a surfactant into water. For example, an acrylic resin or styrene-acryl-type resin emulsion is obtained by mixing a(n) (meth)acrylate or styrene and a(n) (meth)acrylate, and a surfactant into water.

Usually, it is preferable that the mixing ratio of the resin component to the surfactant in the case of manufacturing of an emulsion be about 10:1-5:1. If the content of a used surfactant is less than the above-mentioned ratio, an emulsion may be hardly provided, and on the other hand, if it is more than the above-mentioned ratio, there may be problems that the water resistance of ink may be lowered or the penetrability thereof may be degraded.

The rate of a resin as a dispersed phase component of emulsion to water is 100 parts by weight of the resin to 60-400 parts by weight of water and further preferably is in a range of 100-200 parts by weight.

For commercially available resin emulsions, there are provided Microgels E-1002 and E-5002 (both are commercial names) (styrene-acryl-type resin emulsions, produced by Nippon Paint Co., Ltd.), Boncoat 4001 (commercial name) (acrylic resin emulsion, produced by Dainippon Ink and Chemicals, Incorporated), Boncoat 5454 (commercial name) (styrene-acryl-type resin emulsion, produced by Dainippon Ink and Chemicals, Incorporated), SAE-1014 (commercial name) (styrene-acryl-type resin emulsion, produced by Zeon Corporation), Saibinol SK-200 (commercial name) (acrylic resin emulsion, produced by Saiden Chemical Industry Co., Ltd.), and the like.

In regard to the resin emulsion, its resin component is preferably contained in ink to be 0.1-40% by weight of the ink and more preferably contained to be in a range of 1-25% by weight.

A resin emulsion has thickening and aggregation properties, suppresses penetration of a coloring component, and further exerts the effect of improving the fixation property on a paper sheet. Furthermore, a film is formed on a paper sheet so as to exert the effect of improving the abrasion resistance of a print.

The (8) antiseptic agent and (9) pH adjustor described above are described below.

A conventionally- or publicly-known additive is applicable to ink.

For the antiseptic (antimicrobial) agent, there are provided, for example, sodium dehydroacetate, sodium sorbate, sodium 2-pyridinethiol-1-oxide, sodium benzoate, sodium pentachlorophenoxide, and the like.

For the pH adjustor, it is possible to use any substance as long as the pH of a prepared ink is adjusted to be 7 or greater without adversely affecting it. Specifically, there are provided amines such as diethanolamine and triethanolamine, alkali metal hydroxides such as lithium hydroxide, sodium hydroxide and potassium hydroxide, ammonium hydroxide, quaternary ammonium hydroxides, quaternary phosphonium hydroxides, alkali metal carbonates such as lithium carbonate, sodium carbonate and potassium carbonate, and the like.

A metal ion sequestering agent may be also added as another additive.

For the metal ion sequestering agent, chelating agents may be applicable.

For example, there are provided sodium ethylenediaminetetraacetate, sodium nitrilotriacetate, sodium hydroxyethylethylenediaminetriacetate, sodium diethylenetriaminepentaacetate, sodium uramil diacetate, and the like.

Moreover, a rust-inhibitor may be added as another additive.

For the rust-inhibitor, there are provided, for example, acidic sulfites, sodium thiosulfate, antimony thioglycolate, diisopropylammonium nitrite, pentaerythritol tetranitrate, dicyclohexylammonium nitrite, and the like.

As described above, ink is configured to include a pigment, a water-soluble organic solvent, a polyol or glycol ether with a carbon number of 8 or more, and water, whereby it is possible to attain (1) a good color tone (having a sufficient color development property and color reproducibility), (2) a high image density, (3) a sharp image quality of a character or image without a feathering or color bleed phenomenon, (4) an image with a less ink strike-through which is allowed to conduct double-sided printing, (5) a high drying property (fixation property) suitable to high-speed printing, and (6) a high quality image having a high fastness property such as a light fastness or a water fastness, even when a character is printed on a normal paper sheet, and thus it was also intended to improve some characteristics such as an image density, an image development property, a color reproducibility, character bleeding, color border bleeding, a double-sided printing characteristic, and a fixation property.

Next, a preferred example of a control driving wave pattern in the case where image formation is conducted by an inkjet-type recording apparatus while the ink (recording liquid) described above is used will be described with reference to FIGS. 6, 7, 8A, 8B, 8C, and 8D.

A driving wave pattern generating part 301 illustrated in FIG. 6 is configured to generate and output a driving signal (driving wave pattern) composed of eight driving pulses P1-P8 which are composed of a wave pattern element falling from a reference electric potential Ve, a wave pattern element rising from the post-falling state, and the like, in one printing time period (one driving time period), as illustrated in FIG. 7.

On the other hand, a driving pulse to be used is selected depending on drop control signals M0-M3 from a data transfer part 302 as illustrated in FIG. 6.

Herein, a wave pattern element in which the electric potential V of a driving pulse falls from the reference electric potential Ve is a withdrawal wave pattern element whereby the piezoelectric element 121 is contracted so as to increase the volume of the pressurization liquid chamber 106.

Also, a wave pattern element rising from the post-falling state is a pressurization wave pattern element whereby the piezoelectric element 121 is stretched so as to decrease the volume of the pressurization liquid chamber 106.

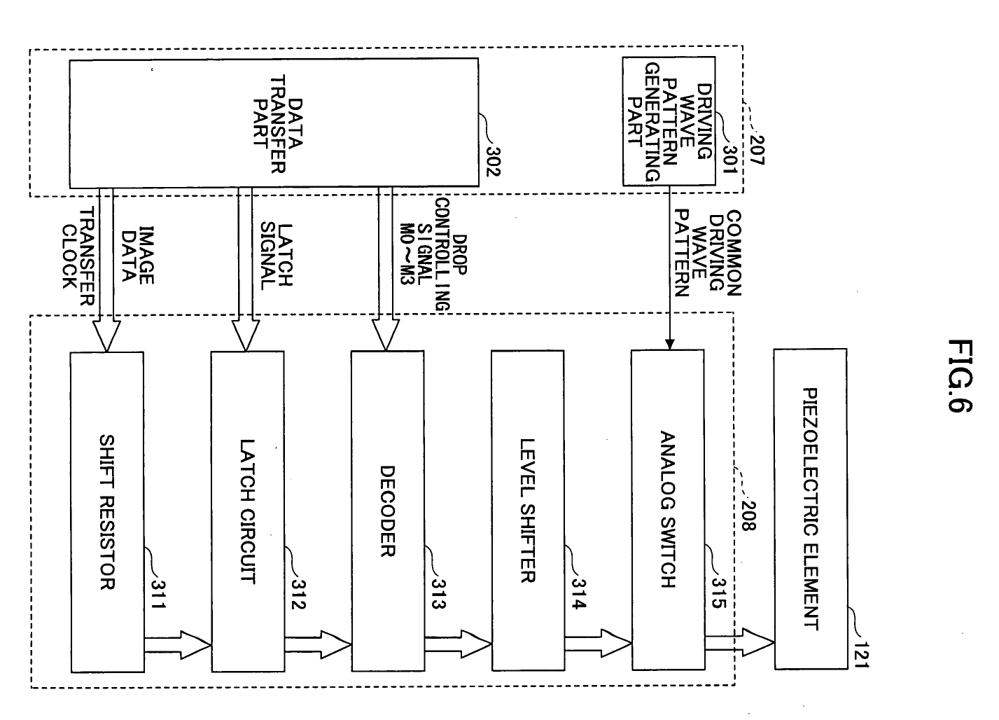

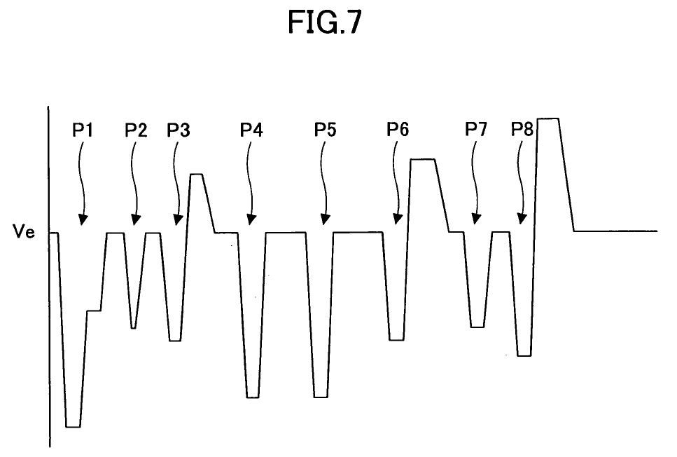

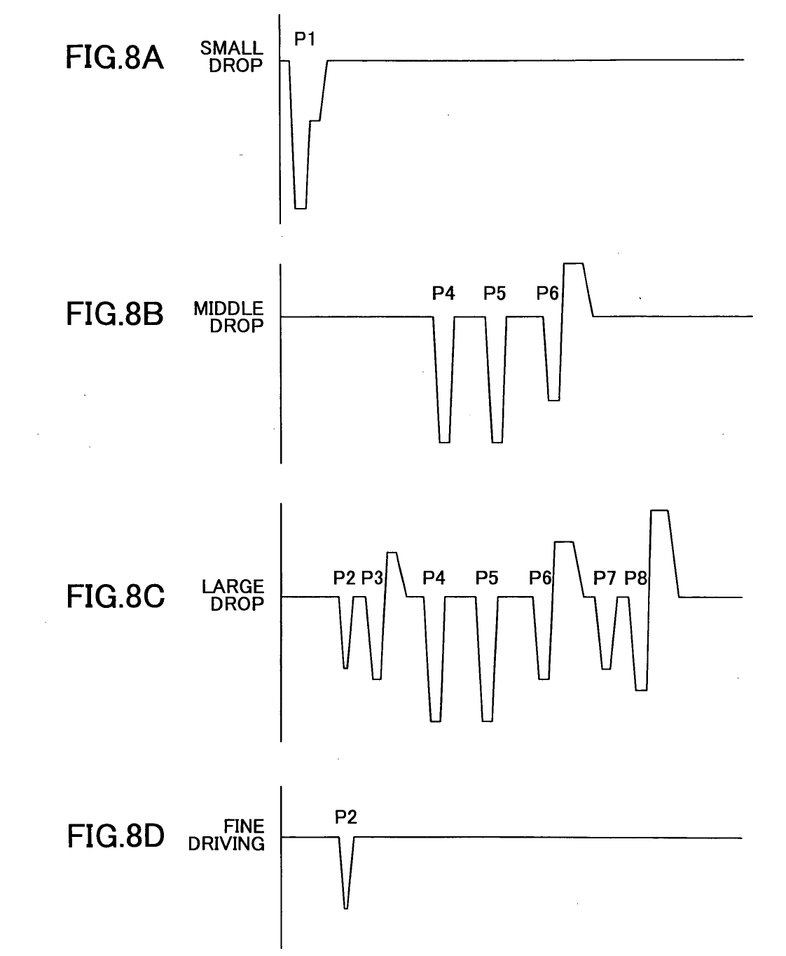

Then, a driving pulse P1 is selected as illustrated in FIG. 8A when a small drop (small dot) is formed; driving pulses P4-P6 are selected as illustrated in FIG. 8B when a middle drop (middle dot) is formed; driving pulses P2-P8 are selected as illustrated in FIG. 8C when a large drop (large dot) is formed; and further, a fine driving pulse P2 is selected as illustrated in FIG. 8D at the time of fine driving (a meniscus being vibrated without drop ejection); depending on the drop control signals M0-M3 from the data transfer part 302, and one of them is applied to the piezoelectric element 121 (as illustrated in FIG. 6) of the recording head 7.

When a middle drop among ink liquid drops is formed, a first drop, a second drop, and a third drop are ejected by a driving pulse P4, a driving pulse P5, and a driving pulse P6, respectively, as illustrated in FIGS. 8A, 8B, 8C, and 8D, and integrated into one drop during their flight, which is landed.

Then, as the natural vibration period of the liquid chamber (pressure chamber) 106 illustrated in FIG. 3 and FIG. 4 is Tc, it is preferable that the interval between the timings of ejection at the driving pulses P4 and P5 be 2Tc±0.5 μs.

Because the driving pulses P4 and P5 are composed of simple withdrawal ejection wave pattern elements, the speed of an ink drop may be too high to displace from the landing position of another kind of drop when the driving pulse P6 is similarly a simple withdrawal ejection wave pattern element. Then, the withdrawal voltage of the driving pulse P6 is reduced (the falling electric potential is reduced) whereby it is possible to reduce the withdrawal of the meniscus and control the speed of the third ink drop. However, a rising voltage is not reduced in order to keep a necessary volume of an ink drop.

That is, the withdrawal voltage of the withdrawal wave pattern element of the last driving pulse among the plural driving pulses is relatively small, whereby the speed of drop ejection caused by the last driving pulse is relatively small and the landing position is coincident with that of another kind of drop as much as possible.

Furthermore, the fine driving pulse P2 is a driving wave pattern for vibrating the meniscus without ejecting an ink drop in order to prevent the meniscus of a nozzle from drying. In a non-character-printing area, the fine driving pulse P2 is applied to a recording head.

Also, a reduction of the driving time period (speeding up) may be attained by utilizing the driving pulse P2 that is a fine driving wave pattern, as one of driving pulses providing a large drop.

Moreover, the interval between the timings of ejection at the fine driving pulse P2 and driving pulse P3 is set within a range of the natural vibration period 2Tc±0.5 μs, thereby obtaining the effect of keeping the volume of an ink drop ejected at the driving pulse P3.

That is, the volume increase of the pressurized liquid chamber 106 at the driving pulse P3 is combined with the pressure vibration of the pressurized liquid chamber 106 depending on a period of vibration caused by the fine driving pulse P2, whereby the drop volume of a drop ejectable at the driving pulse P3 may be larger than that of the case where the driving pulse P3 is applied solely.

Additionally, a necessary driving wave pattern is changed depending on the viscosity of ink.

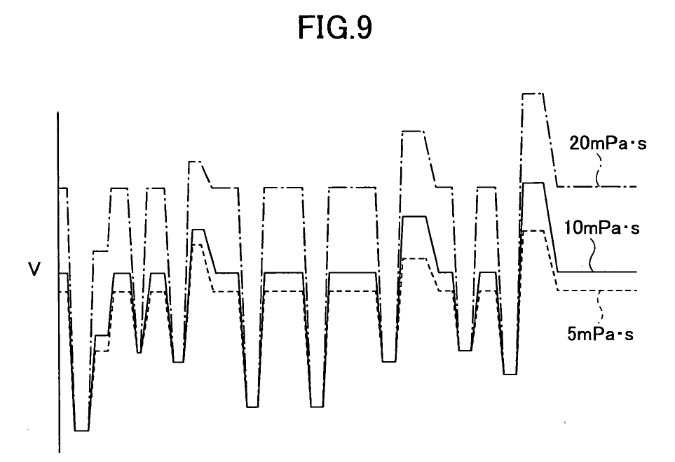

For the measure for this matter, a driving wave pattern at a ink viscosity of 5 mPa·s, a driving wave pattern at the viscosity of 10 mPa·s, and a driving wave pattern at 20 mPa·s are all prepared as specifically illustrated in FIG. 9, and it is preferable to determine an ink viscosity from a temperature detected by a temperature sensor and select a driving wave pattern to be used.

That is, when an ink viscosity is small, the voltage of a driving pulse is relatively small, and when an ink viscosity is large, the voltage of a driving pulse is relatively large, whereby it is possible to eject an ink drop with substantially constant velocity and volume independently of an ink viscosity (temperature).

Furthermore, the peak-to-peak value of the driving pulse 2 is selected depending on an ink viscosity, whereby it is possible to vibrate the meniscus without ejecting an ink drop. A driving wave pattern composed of such a driving pulse is used whereby it is possible to a time period for landing of each of large, middle, and small drops onto a paper sheet, and even if the start time of ejection is different among large, middle, and small drops, it may be possible to land each drop on a substantially same position.

An image forming method according to a specific example of the present invention is conducted by means of a certain control program for executing image processing for generating output data for ejecting a liquid drop of recording liquid so as to form an image.

The manner of installation of the control program in a device or apparatus is not particularly limited and any configuration of conventionally- or publicly-known device may be applicable. The configuration of the device or apparatus is not particularly limited as long as image processing is conducted by means of a control program for executing an image forming method according to a specific example of the present invention.

That is, for example, an image forming apparatus with a configuration such that an image processing part for executing image processing for generating output data is integrated with an output part may be provided, or an image processing device for executing image processing and an image forming apparatus being an output part and including a recording head may be separately provided but configured to provide an image forming system as a whole.

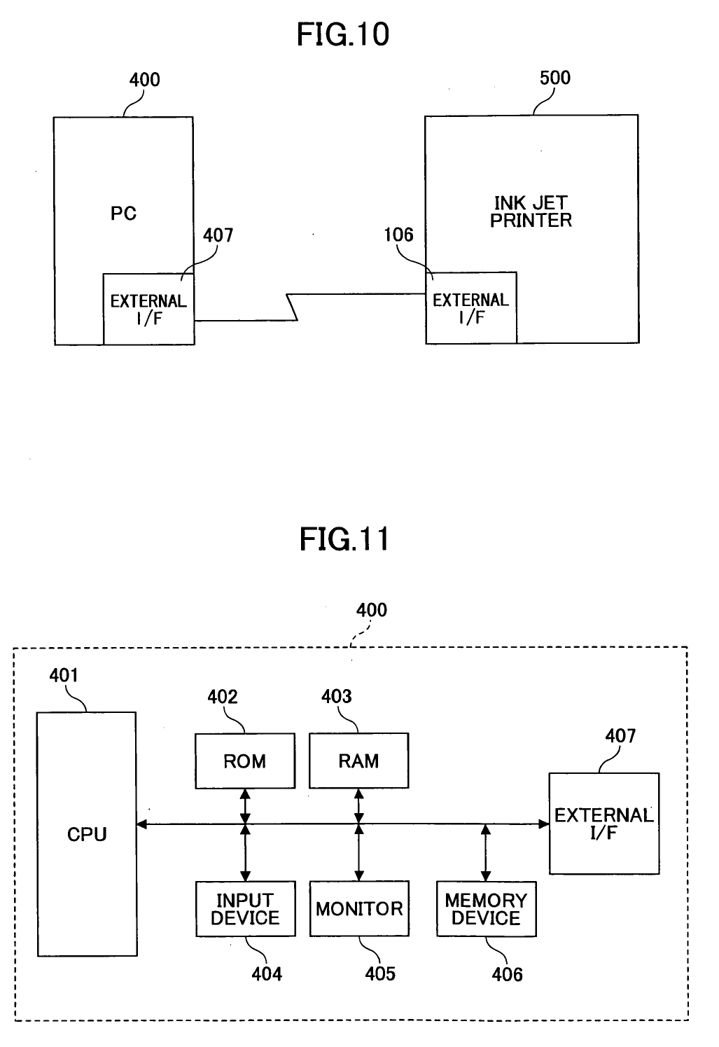

One example of an image forming system for executing an image forming method according to a specific example of the present invention is described with reference to FIG. 10.

An image forming system has a configuration such that one or more image processing devices 400 composed of a personal computer (PC) and the like are connected to an ink jet printer 500 via a predetermined interface or network.

As illustrated in FIG. 11, a CPU 401 is connected to each kind of ROM 402 and RAM 403 as memory devices via bus lines in the image processing device 400.

To the bus lines, a memory device 406 such as a hard disk, an input device 404 such as a mouse or a key board, a monitor 405 such as an LCD or a CRT, and a recording medium reading device for reading a recording medium such as an optical disk (not illustrated in the figure) are connected via predetermined interfaces and also connected to a predetermined interface (external I/F) 407 for conducting communication with an external instrument such as a network such as the inter net or a USB.

An image processing program including a program according to a specific example of the present invention is stored in the memory device 406 of the image processing device 400.

The image processing program is read by a recording medium reading device or downloaded from a network such as the internet so as to be installed in the memory device 406.

Due to the installation, the image processing device is on the condition that it is possible to conduct an image processing operation applicable to an image forming method according to a specific example of the present invention.

Additionally, the image processing program may be operational on a predetermined OS or may be a part of a particular application software.

Also, it is possible to conduct an image processing method according to a specific example of the present invention at the ink jet printer side which is the output side.

By way of example, there is described an example of an ink jet printer which solely has no function of generating a dot pattern in response to a image drawing or character printing command at the side thereof.

That is, a printing command from an application software or the like which is conducted by the image processing device 400 that is a host is image-processed by a printer driver installed in the image processing device 400 (host computer) as a software, thereby generating many-valued dot pattern data (printing image data) capable of being output from an ink jet printer 500.

Then, the data are rasterized, transferred to the ink jet printer 500 and printed and output from the ink jet printer 500.

Specifically, an image drawing or character recording command from an application software or an operating system (for example, in which the position, width, form and the like of a line to be recorded are specified or in which the font, size, position and the like of a character to be recorded are specified) is temporarily stored in an image data memory in the image processing device 400.

Additionally, the command is described in a particular print language. Then, the command stored in the drawing image data memory is interpreted by a rasterizer, and in the case of a line recording command, it is converted into a recording dot pattern dependent on specified position, width and the like. Also, in the case of a character recording command, it is converted into a recording dot pattern dependent on the specified position and size while calling corresponding character outline information from font outline data saved in the image processing device 400, and in the case of image data, it is converted into a recording dot pattern without change.

Subsequently, these recording dot patterns (image data 410) are subjected to image processing and stored in a raster data memory. Then, the image processing device 400 conducts rasterizing into recording dot pattern data while basic recording positions are on orthogonal grids. For image processing, there are provided, for example, color management (CMM) processing for color adjustment, γ-correction processing, halftone processing such as a dither method or an error diffusion method, background removal processing, ink total quantity regulation processing, and the like.

Then, the recording dot patterns recorded in the raster data memory are transferred to the ink jet recording apparatus 500 via an interface.

Next, a specific operation for an image forming method according to a specific example of the present invention will be described.

A specific example of the present invention is conducted in various kinds of image forming apparatus or image forming systems including a function of ejecting a liquid drop of the above-mentioned recording liquid (ink) to form an image composed of plural dots.

The image is composed of a background portion and a character portion.

The background portion and the character portion are composed of different colors. By way of example, a colored background portion and a white blank character portion are provided and the method according to a specific example of the present invention is not limited to the example. It is only necessary that the character portion and the background portion have different colors.

The method according to a specific example of the present invention aims to improve the visibility of a character portion and is characterized by conducting addition of a dot with the same color as that of the character portion to the contour portion of the character portion.

In regard to the dot addition, the brightness characteristics of the character portion and background portion are detected and then switching on/off is conducted.

That is, a so-called process for “thickening” a character portion (which may be referred to as a character thickening process, below) is conducted to improve the visibility of a character.

More specific descriptions are provided below.

Although an image with a black background portion and a white character portion is formed in this example, it is obvious that it is not limited to this example and it is also possible to obtain the effect of improving the visibility of a colored character with a background portion by means of application of similar image processing.

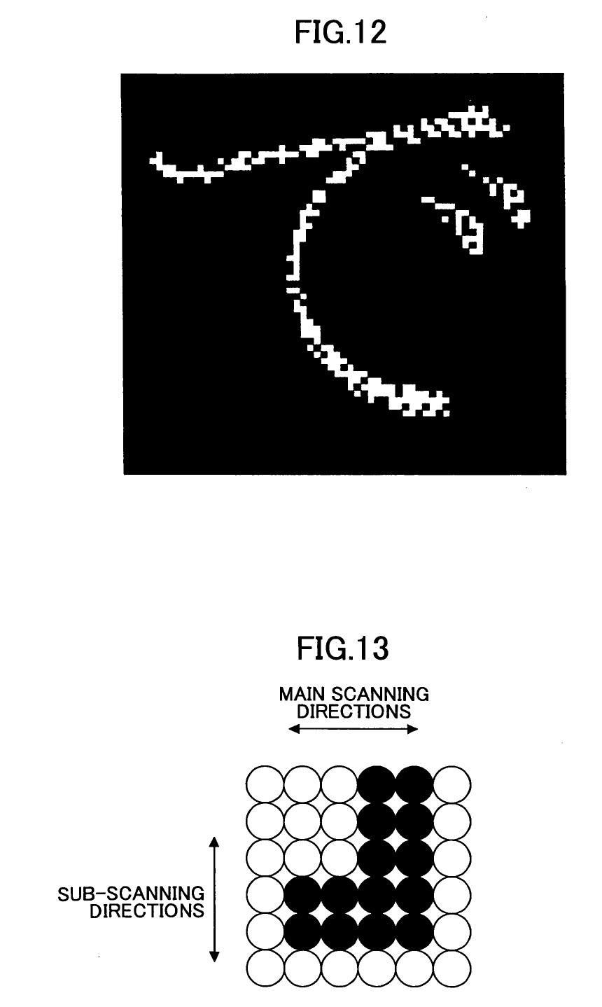

First, FIG. 12 illustrates an output example in the case where no character thickening process is conducted and FIG. 13 illustrates a partially enlarged view of the case based on a dot size.

In FIG. 13, an image is formed whose resolution in the sub-scanning directions is the same resolution as a nozzle pitch (in this example, 300 dpi) and that in the main scanning directions is denser than that of the sub-scanning directions (in this example, 600 dpi, twice as high as that of the sub-scanning directions).

Additionally, in FIG. 13, a white blank character or image portion and a background portion are denoted by a filled circle and an open circle, respectively, for convenience. Therefore, in fact, no drop has landed on a filled circle, which is blank (which is similar in the followings).

Furthermore, because the resolution in the main scanning directions is twice as high as that of the sub-scanning directions, two dots in the main scanning directions correspond to one dot in the sub-scanning directions but the main scanning directions are enlarged and drawn to be twice the sub-scanning directions for convenience of illustration (which is similar in the followings).

As illustrated in FIG. 12, no character thickening process is conducted, dot landing is conducted while width selection is automatically depending on the shape of a character, and therefore, if black ink in a background portion bleeds, it permeates into a character portion whereby its contour portion blurs so that it may be impossible to obtain a good visibility.

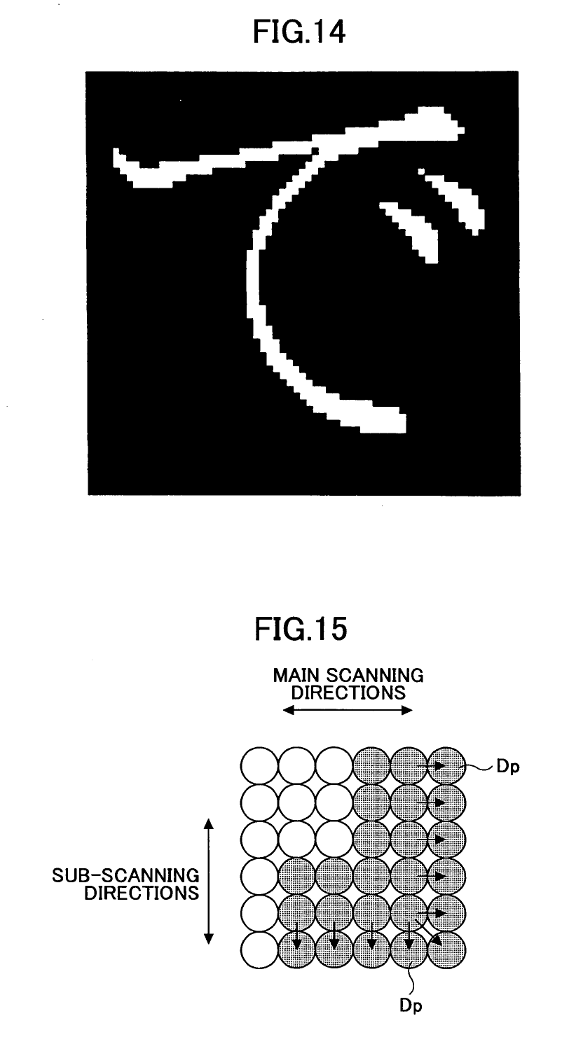

On the other hand, FIG. 14 illustrates an output example in the case where a character thickening process is conducted and FIG. 15 illustrates its partially enlarged view based on a dot size.

As illustrated in FIG. 15, a character thickening process is conducted by adding large drop (or a large) dots Dp (one dot in the sub-scanning directions and one dot in the main scanning directions) to the dots of a background portion adjacent to the dots forming a character portion while an ink with the same color as that of a character portion is used.

By this processing, a border portion between a blackened dot portion in a background portion and a white character portion is subjected to a character thickening process, and even if ink in the black background portion bleeds, a white blank character portion is thickened and therefore is prevented from being vague or invisible so that it is possible to obtain a good image quality.

The size of a dot to be added is not particularly limited.

That is, the dot size may be changed depending on the resolution.

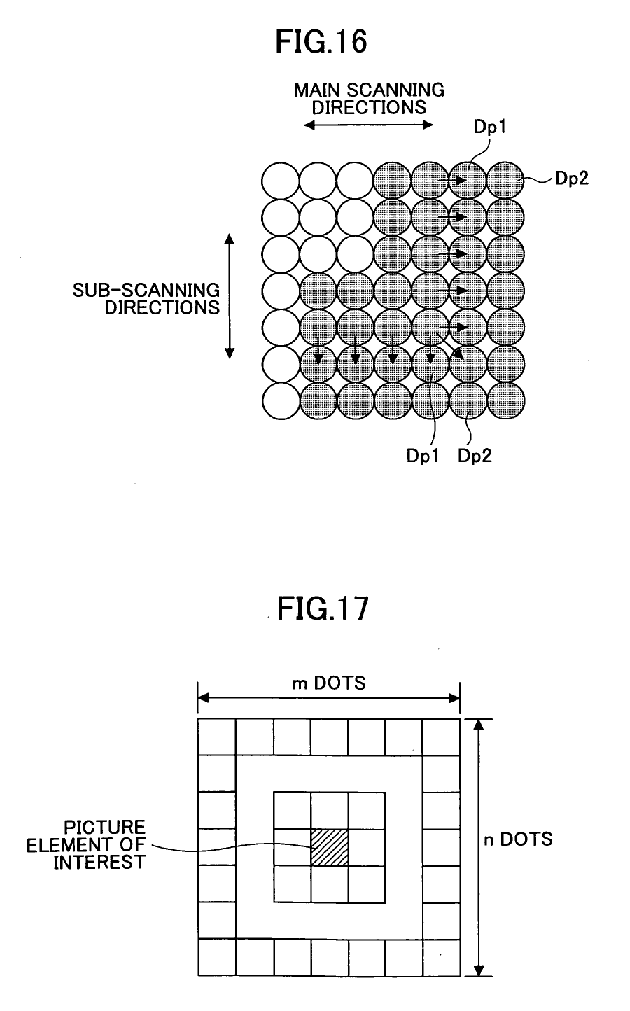

For an example of a high resolution, the case of 600 dpi×600 dpi is described with reference to FIG. 16.

In this example, additional dots that are added to a white blank character are two dots (dots Dp1 and Dp2).

In the case of a high resolution, it is preferable that dot addition be controlled appropriately, because one dot addition may less thicken a white blank character and may not provide a size change sufficient to prevent bleeding of a background blackened portion.

That is, whereas the degree of bleeding of a blackened portion of a background portion is generally constant independently of the resolution in the border between the black background portion and a white character portion, the size change of a white character due to one dot addition is changed depending on the resolution, and therefore, when the number of dot(s) to be added is controlled or adjusted depending on the resolution, it is possible to conduct a character thickening process suitable to the resolution.

Next, a specific method for a character thickening process will be described.

For a method for adding a large drop beside or under dots forming a character, pattern matching is preferable. When this method is applied, high speed processing is possible.

FIG. 17 is a schematic diagram of one example of a window to be used in pattern matching.

The size of a window is m in the horizontal directions by n in the vertical directions (m×n).

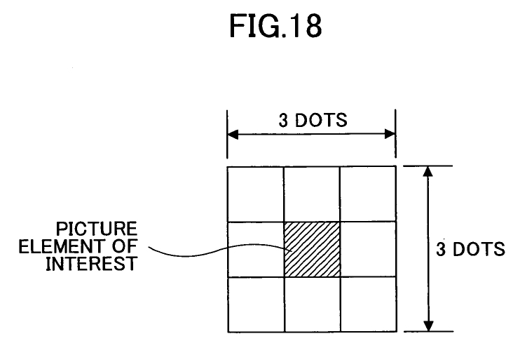

In this example, m and n are the same value, and as illustrated in FIG. 18, a window of m=3 and n=3 is provided.

Font data are converted into bitmap data by means of a printer driver software.

The bitmap data represent dots forming a font.

Pattern matching is applied to each bit of the bitmap data for the font data by the above-mentioned window unit.

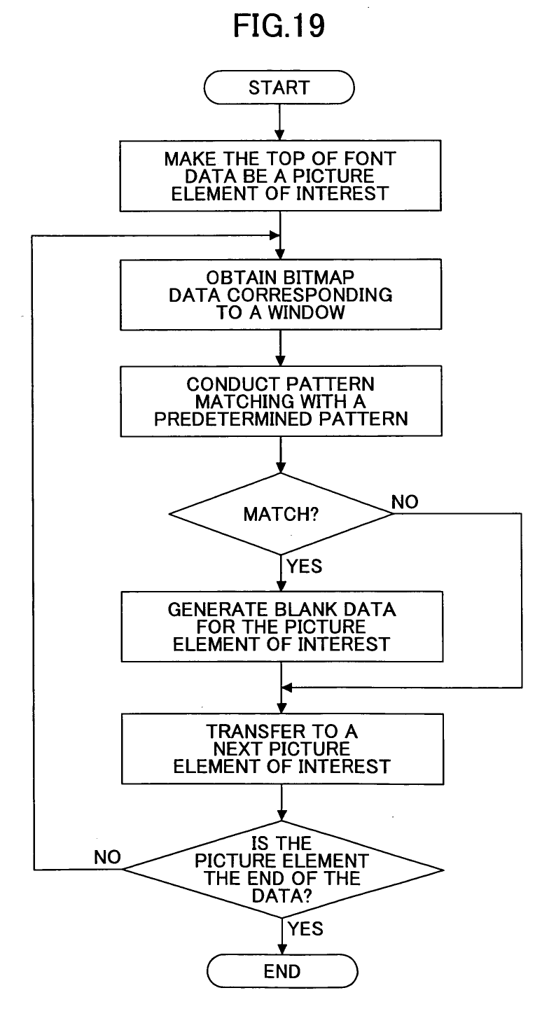

One example of a pattern matching process (character thickening process) conducted by a printer driver is described with reference to an operation flow illustrated in FIG. 19.

First, a picture element of interest is set on the top of font data.

The bitmap data of font data corresponding to a window centered on the picture element of interest are obtained.

In this case, the obtained bitmap data are data of 3×3 dots (9 dots).

The obtained data are compared to the a preset blank addition pattern (referred to as “reference pattern” below) data by means of pattern matching, and if matching, a dot is added to the picture element of interest.

In these processes, 1 picture element may be dealt with as a 1-byte data or may be dealt with as 1-bit data.

Whereas 9 bytes are necessary to represent 9-dots-data in the case of dealing as 1-byte data, only 2 bytes data quantity are necessary to represent 9-dot-data in the case of dealing as 1-bit data, and therefore, the dealing as 1-bit data is preferable in that the number of data to be processed is small and it may be possible to save a memory and improve a processing speed.

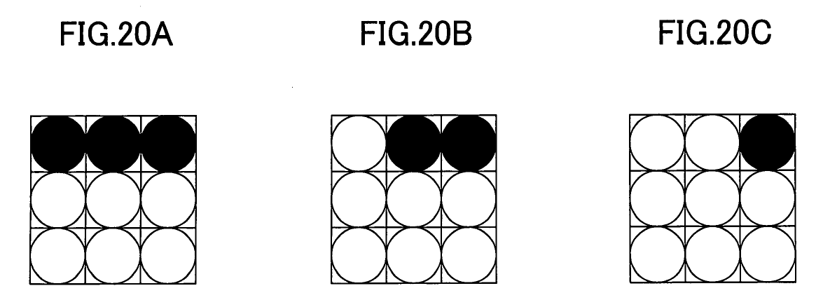

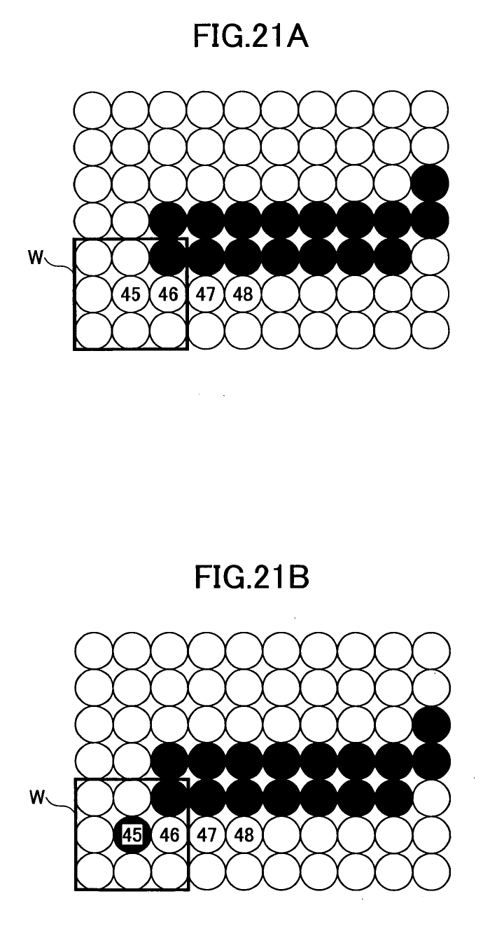

An example of the above-mentioned pattern matching is specifically described with reference to FIGS. 20A, 20B and 20C and FIGS. 21A and 21B.

FIGS. 20A, 20B and 20C illustrate one example of a reference pattern.

When pattern matching is conducted for font data illustrated in FIG. 21A using the reference pattern, the states of dots included in a window W in the case where the position of a picture element (dot position) D45 of the font data is on a picture element of interest, as illustrated in FIG. 21A, are identical to those of a reference pattern illustrated in FIG. 20C, and therefore, the dot datum of the picture element of interest D45 is replaced with blank as illustrated in FIG. 21B (for a white character, replacement with blank is conducted by dot addition).

Similarly, when the window W moves toward the right by one unit and the picture element of interest is D46, they are identical to those of a reference pattern of FIG. 20B, and therefore, the dot datum of the picture element of interest D46 is replaced with blank. Also, when the window further moves toward the right by one unit and the picture element of interest is D47, they are identical to those of a reference pattern of FIG. 20A, and therefore, the dot datum of the picture element of interest is replaced with blank.

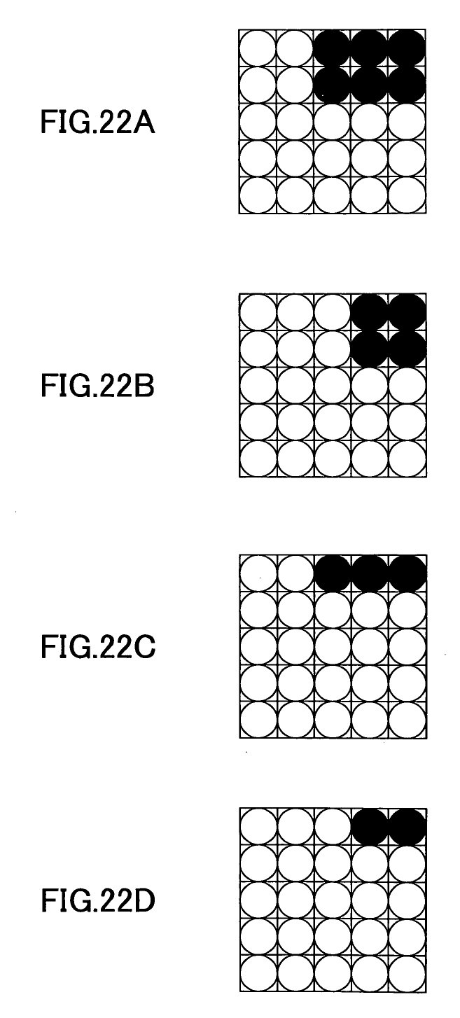

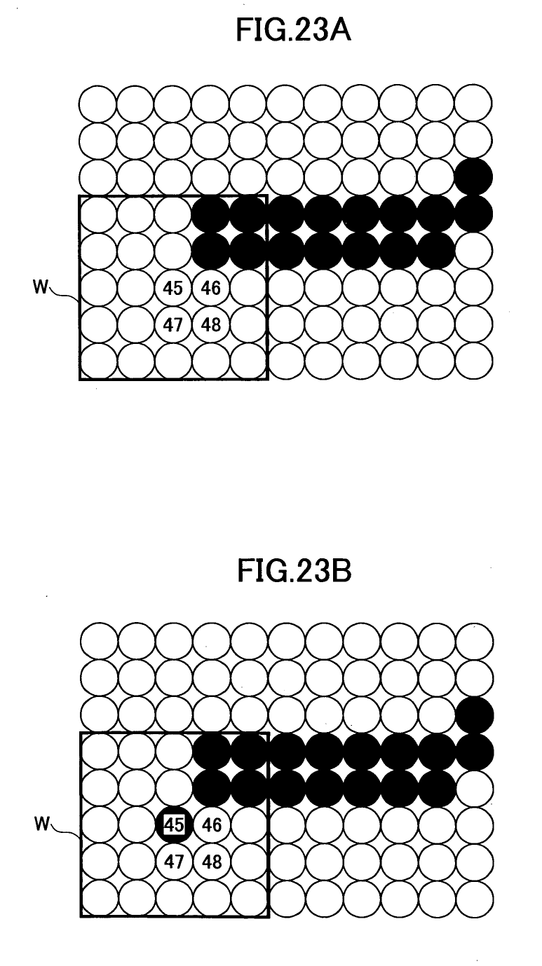

Next, an example of attainment of character thickening of a 2-dot-while blank character using a reference pattern with a size of 5×5 will be described as another example, with reference to FIGS. 22A, 22B, 22C and 22D and FIGS. 23A and 23B.

FIGS. 22A, 22B, 22C and 22D illustrate one example of a reference pattern.

When pattern matching is conducted for font data illustrated in FIG. 23A using the reference pattern, the states of dots included in a window W in the case where the position of a picture element (dot position) D45 of the font data is on a picture element of interest, as illustrated in FIG. 23A, are identical to those of a reference pattern illustrated in FIG. 23B, and therefore, the dot datum of the picture element of interest D45 is replaced with blank as illustrated in FIG. 23B.

Similarly, a picture element of interest D46, a picture element of interest D47, and a picture element of interest D48 are replaced with blank dots in accordance with a reference pattern of FIG. 22A, a reference pattern of FIG. 22C, and a reference pattern of FIG. 22D, respectively.

Thus, the square-arranged 4 dots on the contour of a white blank character are replaced with blank data.

The reason why it is applicable to the square-arranged 4 dots on the contour of a white blank character is that, for example, when a window with a size of 3×3 is used and the position of the picture element D47 in FIGS. 23A and 23B is on a picture element of interest, the contour is outside the window and therefore it is impossible to detect a character portion. When this is solved and a blank dot is also added to the position of the picture element D47, it is possible by making the sizes of a window and reference pattern be 5×5.

That is, it is possible to address the number of dot(s) to be added by increasing the sizes of a window and reference pattern.

Although the character portion is a white character and a blank dot is added to an input image in any of the above-mentioned examples, in the case where the character portion is a colored character, an ink dot of the color is added to conduct a character thickening process.

Herein, the sizes of a window and reference pattern are not limited to those used in the above-mentioned examples, and are determined by appropriately determining how much dot replacement is needed to conduct or whether processing time is provided to be in time for a printing speed.

More particularly, when the size of a reference pattern is increased, data for pattern matching is also increased, and therefore, it takes much time to conduct the pattern matching. Thus, it is preferable that the size is as small as possible, from the viewpoint of a processing time.

Meanwhile, how many square-arranged dots on a contour portion should be replaced is determined by a target character quality or how much the vagueness of a character is eliminated. That is, the optimum size is determined from the viewpoints of both a processing speed and a character quality.

Furthermore, a recording paper sheet is not limited to a normal paper sheet and it is similarly applicable to the case of character printing on a coated paper sheet, a glossy paper sheet, an OHP film, or the like.

Moreover, it is possible to select appropriately with respect to whether a character thickening process is conducted or not, depending on the kind of paper.

That is, the optimum character thickening process is conducted depending on a readily-bleeding paper sheet, a hardly-bleeding paper sheet, or the size of a character to be printed.

Furthermore, although the examples of printing of a character with resolutions of 300 dpi×300 dpi and 600 dpi×600 dpi are illustrated herein, a similar effect is obtained for other resolutions.

Moreover, it is similarly effective even when the resolutions in the main scanning directions and sub-scanning directions are different, such as 600 dpi×300 dpi, 400 dpi×200 dpi, and 300 dpi×150 dpi.

On the other hand, for example, in the case of a low resolution such as 150 dpi×150 dpi, when one dot addition is applied, a character may be thickened excessively so that adjacent characters may be integrated or a character, per se, may become vague. Therefore, on/off selection should be allowed which appropriately switches between and conducts a mode for conducting a character thickening process and a normal mode for conducting no character thickening process depending on the resolution.

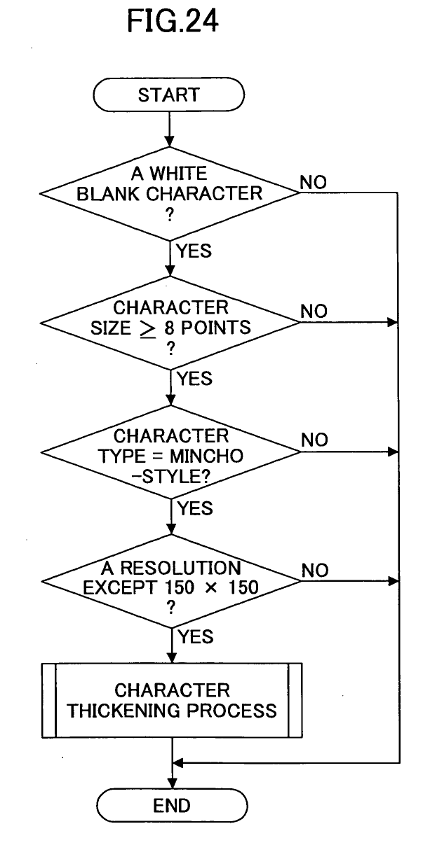

That is, as illustrated in FIG. 24, switching between a mode for conducting a character thickening process and a normal mode for conducting no character thickening process is made depending on a character size, a character kind, and an image resolution.

Next, a character thickening process in the case where no pattern matching is used will be described.

As described above, there is a problem that a processing time required for pattern matching is increased as the size of data is increased. Furthermore, a memory used for processing is finite and it takes more processing time for a small memory.

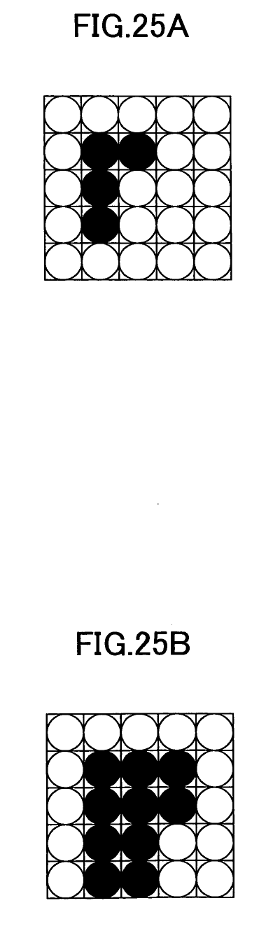

Then, a character thickening process is useful by uniformly adding a dot(s) to a character pattern without conducting pattern matching. This is described with reference to FIGS. 25A and 25B.

In this example, dot addition, i.e. 1 dot onto the right side and one dot onto the lower side, as illustrated in FIG. 25B, is applied to image data illustrated in FIG. 25A so as to thicken a character portion.

When dots are added to any of the left and right or upper and lower sides, a character may become vague with respect to a small size character (for example, 6 pt) with small character spacing, and accordingly, dot addition is applied for only one side in this example, but it is possible to change or adjust a pattern of addition depending on a character size.

Furthermore, it may be possible to change a pattern of addition depending on a character size, a character kind and an image resolution similarly to the above-mentioned pattern matching, or it may possible to thicken a character with a low resolution using pattern matching and to apply uniform thickening and switching for a high resolution.

Moreover, it is possible to compare a background portion and a character portion so as to change the level of character thickening.

In this example, the brightness characteristics of a character portion and background portion are detected and they are compared whereby dot addition control is conducted for a desired position.

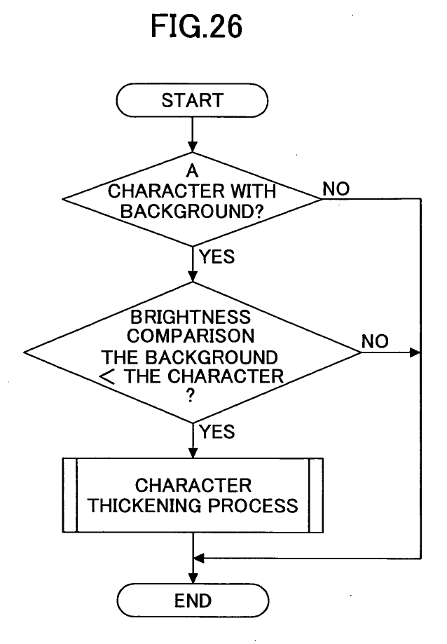

That is, as illustrated in FIG. 26, the brightness characteristics of a background portion and character portion are compared, and switching on/off is conducted such that if the character portion has a lower brightness, character thickening is not conducted, and on the contrary, when the brightness is higher, a character thickening process is conducted.

Furthermore, it is also possible to change the degree (or level) of a conducted character thickening process depending on the brightness difference between a background portion and a character portion.

Moreover, switching on/off of conducting of a character thickening process may be controlled such that the quantities of ink added to a background portion and character portion are compared, wherein when the quantity of ink added to the background portion is smaller, character thickening is not conducted, and on the contrary, the quantity of the added ink is larger, thickening is conducted.

Furthermore, it may be possible to a thickening level depending on the difference between the quantities of ink added to a background portion and character portion.

After a character thickening process is conducted by the method described above, input data are converted into a dot pattern on a halftone processing part.

Additionally, the case where the recording head is a piezoelectric head using a piezoelectric element has been described in any of the above-mentioned specific examples, it is not limited to this one and a thermal head may be provided which conducts drop ejection by means of film boiling using an electrothermal conversion element.

As described above, a piezoelectric head is allowed to eject ink drops with different sizes in response to a driving wave pattern, and has an advantage such that a gradient image is readily formed.

On the other hand, a thermal head is advantageous for printing a high resolution image at a high speed because high integration of nozzles is readily attained.

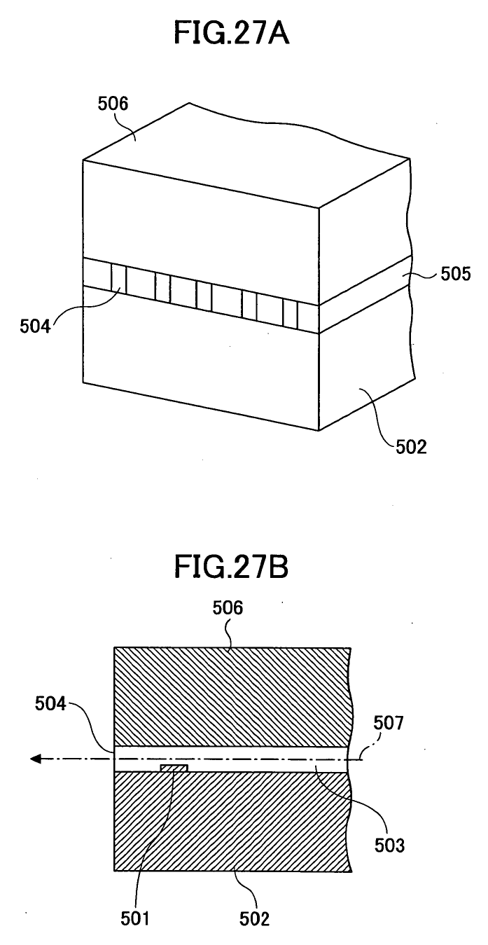

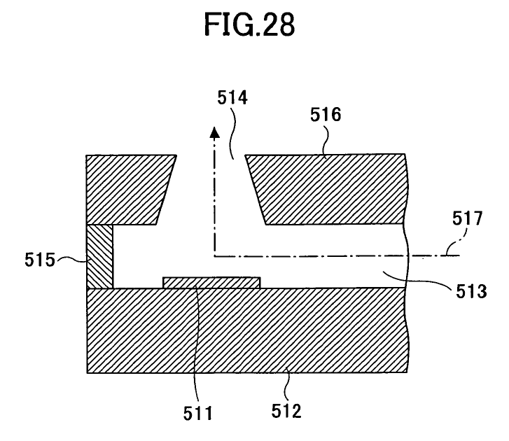

Herein, different examples of a thermal head are described with reference to FIGS. 27A and 27B and FIG. 28.

A recording head illustrated in FIGS. 27A and 27B is an edge-shooter-type head which is configured such that a wall material 505 composing a flow channel 503 and a nozzle 504 and a top plate 506 composing a cover of the flow channel 503 are stacked on a substrate 502 having an ejection energy generator 501 (wherein electrodes for applying an ejection signal to the generator, a protective layer provided on the generator according to need, and the like are omitted).

In the recording head, ink goes straight from the flow channel 503 to the nozzle 504 as illustrated by a dashed line 507 in the figure.

When a recording signal is applied to the energy generator 501 by means of certain electrodes (not illustrated in the figures) on the condition that the flow channel 503 is filled with ink from a certain liquid chamber (not illustrated in the figures) in which the ink is stored, ejection energy generated by the ejection energy generator 501 is applied on ink in the flow channel 503 above the generator 501 (at an ejection energy application part), and consequently, the ink is ejected from the nozzle 504 as a liquid drop.

Such an edge-shooter-type head may have advantages such that miniaturization of each part with a high precision, use of multiple nozzles, or downsizing is readily attained and it is suitable for mass production thereof.

Furthermore, while gas bubbles are generated in ink by heating an electrothermal conversion element, a so-called cavitation phenomenon may occur in which the ejection energy generator 501 is gradually broken by means of impact at a time when the gas bubbles contract due to temperature decrease and vanish near the ejection energy generator 501, so that there may be a disadvantage of a relatively short life span.

A recording head illustrated in FIG. 28 is a side-shooter-type head which is configured such that a flow channel forming member 515 composing a side wall of the flow channel 513 is stacked on a substrate 512 having an ejection energy generator 511 (wherein electrodes for applying an ejection signal to the generator, a protective layer provided on the generator according to need, and the like are omitted) and a nozzle plate 516 forming a nozzle 514 is stacked on the flow channel forming member 515.

In such a recording head, the direction of ink flow toward an ejection energy application part in the flow channel 513 is perpendicular to the central axis of the opening of the nozzle 514 as illustrated by a dashed line 517.

Such a configuration may have a structural advantage such that it is possible to convert energy from the ejection energy generator 511 to energy for formation of an ink drop and kinetic energy of its traveling more efficiently and recovery of the meniscus due to ink supply is speedy, and may be particularly effective in the case where a heating element is used for the ejection energy generator.

Furthermore, it may be possible for the side-shooter-type one to prevent a so-called cavitation phenomenon problematic in the edge-shooter in which an ejection energy generator is gradually broken by means of impact at a when gas bubbles vanish. That is, the side-shooter-type one may have an advantage of an excellent durability, because when gas bubbles grow and the gas bubbles reach a nozzle, the gas bubbles communicate with atmospheric air so that air bubble contraction due to temperature decrease does not occur.

Additionally, in regard to device or apparatus for implementing a method according to an example of the present invention, it may also be possible that an image forming apparatus, per se, has a configuration with a device for executing the above-mentioned image processing method. Also, it may be possible to provide a configuration such that an application specific integrated circuit (ASIC) for executing an image processing method according to an example of the present invention is installed in an image forming apparatus.

According to a ninth illustrative embodiment of the present invention, there may be provided a computer-readable recording medium in which a program configured to cause an image processing part to execute an image processing operation of creating an output datum configured to form an image by ejecting a liquid drop of recording liquid is recorded, wherein the image processing part is caused to execute the image forming method according to any one of the first to fourth illustrative embodiments of the present invention.

For example, a computer-readable recording medium may be a computer-readable optical recording medium such as a CD-ROM or a computer-readable magnetic recording medium such as a floppy disk or a memory card.

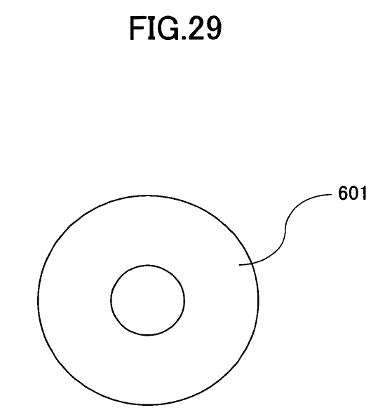

FIG. 29 is a schematic diagram illustrating one example of a computer-readable recording medium according to a specific example of the present invention.

An computer-readable optical recording medium 601 includes a data signal sequence of a program for conducting an image forming method according toga specific example of the present invention, wherein the program may be a control program for executing image processing for generating output data for ejecting a liquid drop of recording liquid so as to form an image, as described above.

Although the illustrative embodiments and specific examples of the present invention have been described above with reference to the accompanying drawings, the present invention is not limited to any of the illustrative embodiments and specific examples and the illustrative embodiments and specific examples may be altered or modified without departing from the scope of the present invention.

The present application claims the benefit of the priority based on Japanese Patent application No. 2008-025294 filed on Feb. 5, 2008 in Japan, the entire contents of which are hereby incorporated by reference herein.

What is claimed is:

1. An image forming method comprising:
forming an image comprising plural dots by using liquid drops of recording liquid, the image comprising a background portion and a character portion;
detecting brightness characteristics of the character portion and background portion; and
switching dot addition on or off;
wherein a dot with a color identical to a color of the character portion is added to a contour portion of the character portion when the dot addition is switched on.

2. The image forming method as claimed in claim 1, wherein the dot addition is controlled based on the brightness characteristics of the character portion and background portion.

3. The image forming method as claimed in claim 1, wherein the brightness characteristics are detected based on a quantity of recording liquid used for the character portion and background portion.

4. The image forming method as claimed in claim 1, wherein pattern matching between a pattern within an m×n window comprising a picture element of interest and a predetermined pattern is used to determine whether the dot addition is switched on or off.

5. A computer-readable recording medium comprising a program recorded therein, wherein the program is configured to cause a computer to execute the image forming method as claimed in claim 1.

6. An image processing device, comprising:
a central processing unit configured to control the image processing device in accordance with a program; and
a memory device comprising the program installed therein,
wherein the program is configured to cause the image processing device to execute the image forming method as claimed in claim 1.

7. An image forming apparatus, comprising:
a recording head configured to eject a liquid drop of recording liquid to form an image; and
an image processing part, the image processing part comprising a central processing unit configured to control the image processing part in accordance with a program and a memory device comprising the program installed therein,
wherein the program is configured to cause the image processing part to execute the image forming method as claimed in claim 1.

8. An image forming system, comprising:
the image processing device as claimed in claim 6; and
an image forming apparatus comprising a recording head configured to eject a liquid drop of recording liquid to form an image.
